(19) United States
(12) Patent Application Publication
(10) Pub. No.: US 2014/0307052 A1
(43) Pub. Date: Oct. 16, 2014

(54) APPARATUSES AND METHODS FOR EXTRACTING DEFECT DEPTH INFORMATION AND METHODS OF IMPROVING SEMICONDUCTOR DEVICE MANUFACTURING PROCESSES USING DEFECT DEPTH INFORMATION

(71) Applicant: Samsung Electronics Co., Ltd., Suwon-si (KR)

(72) Inventors: Jeong-ho Ahn, Hwaseong-si (KR); Jong-cheon Sun, Seoul (KR); Dong-ryul Lee, Suwon-si (KR); Byoung-ho Lee, Yongin-si (KR); Dong-chul Ihm, Suwon-si (KR); Soo-bok Chin, Seoul (KR)

(73) Assignee: Samsung Electronics Co., Ltd., Suwon-si (KR)

(21) Appl. No.: 14/248,684

(22) Filed: Apr. 9, 2014

(30) Foreign Application Priority Data
Apr. 10, 2013 (KR) 10-2013-0039512

(51) Int. Cl. G01N 21/95; G02B 21/36; G06T 7/00; G01N 23/22; G01N 23/02

(52) U.S. Cl. CPC G01N 21/9505; G01N 23/2206; G01N 23/02; G06T 7/0008; G06T 7/001; G02B 21/365
USPC 348/46

(57) ABSTRACT

Apparatuses and methods for extracting defect depth information and methods of improving semiconductor device manufacturing processes using defect depth information are provided. The apparatuses may include an inspection assembly configured to obtain a plurality of optical images of a portion of an inspection object including a defect along a depth direction and a processor circuit configured to generate defect data using the plurality of optical images and provide defect depth information by comparing the defect data with comparison data in a library database.

### CROSS-REFERENCE TO RELATED APPLICATION

This U.S. non-provisional patent application claims priority under 35 U.S.C. §119 to Korean Patent Application No. 10-2013-0039512, filed on Apr. 10, 2013, in the Korean Intellectual Property Office, the disclosure of which is hereby incorporated by reference in its entirety.

### FIELD

The present disclosure generally relates to the field of electronics, and more particularly, to inspection of semiconductor devices.

### BACKGROUND

Defects may exist on a surface of a semiconductor device and in a layer as well. Since many methods or apparatuses for inspecting a semiconductor device may not provide defect depth information, it may be difficult to monitor defects.

Methods of estimating defect depth may include a holography method, a scanning electron microscope (SEM) method, and a transmission electron microscope (TEM) method. However, those methods may not be appropriate for use as a defect inspection method. In particular, the SEM method or the TEM method requires destruction of a sample and thus are not appropriate as an in-line monitoring tool.

### SUMMARY

An apparatus for extracting defect depth information may include an optical microscope including a focus adjusting assembly configured to change a focus position. The optical microscope may be configured to obtain a plurality of images of an inspection object by changing the focus position along a depth direction using the focus adjusting assembly. The apparatus may also include an image processor circuit configured to generate an optical intensity image by processing the plurality of images and compare the optical intensity image with comparison images to extract defect depth information and a library database configured to store the comparison images including a plurality of optical intensity images obtained by simulations or experiments.

According to various embodiments, the focus adjusting assembly may be configured to change the focus position by mechanically adjusting a position of the inspection object.

According to various embodiments, the focus adjusting assembly may be configured to change the focus position by adjusting a wavelength of a light irradiated onto the inspection object.

In various embodiments, the optical microscope may include a wavelength tunable laser as a light source and the focus adjusting assembly may be configured to control the wavelength tunable laser to adjust the wavelength of the light.

In various embodiments, the focus adjusting assembly may be configured to adjust the wavelength of the light by using an optical filter.

According to various embodiments, the focus adjusting assembly may be configured to change the focus position by adjusting a light path of a light irradiated onto the inspection object.

In various embodiments, the focus adjusting assembly may be configured to adjust the light path using a plate whose refractive index varies with a radio frequency applied to the plate.

According to various embodiments, the image processor circuit may include a signal processor circuit configured to integrally process the plurality of images received from the optical microscope to generate the optical intensity image and a comparing and determining circuit configured to compare the optical intensity image and the comparison images stored in the library database to extract the defect depth information.

In various embodiments, the signal processor circuit may include a digital signal processor circuit configured to convert the plurality of images received from the optical microscope to a digital signal, an optical intensity profile extractor circuit configured to extract an optical intensity profile from the digital signal and an optical intensity image generator circuit configured to integrate the optical intensity profile to generate the optical intensity image.

According to various embodiments, the image processor circuit may be configured to extract at least one of an optical intensity profile of a portion of the inspection object including a defect along the depth direction, a derivative optical intensity profile of a portion of the inspection object including a defect relative to the depth direction, a difference between a first optical intensity image of a first portion of the inspection object including a defect and a second optical intensity image of a second portion of the inspection object not including defects, and a difference between a first optical intensity profile of a third portion of the inspection object including a defect and a second optical intensity profile of a fourth portion of the inspection object different from the third portion.

In various embodiments, the image processor circuit may be configured to compare at least one of the optical intensity profile, the derivative optical intensity profile, the difference between the first optical intensity image and the second optical intensity image, and the difference between the first optical intensity profile and the second optical intensity profile with comparison data stored in the library database to extract the defect depth information.

According to various embodiments, the apparatus may further include a scanning electron microscope (SEM) or a transmission electron microscope (TEM) configured to obtain cross-sectional analysis result of the inspection object. The library database may be configured to be updated the comparison images using the cross-sectional analysis result.

An apparatus for extracting defect depth information may include an optical microscope configured to obtain a plurality of images of a portion of an inspection object including a defect by changing a focus position along a depth direction with a predetermined interval and an image processor circuit configured to obtain defect data by integrally processing the plurality of images and compare the defect data with comparison data stored in a library database to extract defect depth information. The optical microscope may be configured to change the focus position by at least one of mechanically adjusting a position of the inspection object, adjusting a light wavelength of a light irradiated onto the inspection object, and adjusting a light path of a light irradiated onto the inspection object.

According to various embodiments, adjusting the light wavelength may include adjusting the light wavelength by using a wavelength tunable laser or an optical filter circuit, and adjusting the light path may include adjusting the light path by using a plate whose refractive index varies with a radio frequency applied to the plate.

According to various embodiments, the library database may be configured to store the comparison data obtained by simulations or experiments or may be configured to be updated using SEM or TEM analysis result.

An apparatus for providing defect depth information may include an inspection assembly configured to obtain a plurality of optical images of a portion of an inspection object including a defect along a depth direction and a processor circuit configured to generate defect data using the plurality of optical images and provide defect depth information by comparing the defect data with comparison data in a library database.

According to various embodiments, the defect data may include an optical intensity profile of the portion of the inspection object, a derivative optical intensity profile of the portion of the inspection object relative to the depth direction, an optical intensity image of the portion of the inspection object, a difference between an optical intensity image of the portion of the inspection object and a reference optical intensity image, or a difference between an optical intensity profile of the portion of the inspection object and a reference optical intensity profile.

In various embodiments, the optical intensity image may be obtained by integrating the optical intensity profile.

In various embodiments, the reference optical intensity image may include an optical intensity image of a portion of the inspection object different from the portion of the inspection object including the defect.

According to various embodiments, the processor circuit may be configured to provide defect depth information of a matching comparison data as the defect depth information of the defect included in the portion of the inspection object.

### BRIEF DESCRIPTION OF THE DRAWINGS

FIG. 1 is a diagram illustrating variable focus scanning performed by varying a focus position of an optical microscope of an apparatus for extracting defect depth information according to some embodiments of the present inventive concept.

FIG. 2 provides perspective views of four semiconductor devices including respective defects at different depths and an optical signal image of the four semiconductor devices obtained using a fixed focus scanning.

FIGS. 3A through 3D are drawings illustrating an operation of obtaining defect depth information using a variable focus scanning method with an apparatus according to some embodiments of the present inventive concept.

FIGS. 4A and 4B are block diagrams illustrating apparatuses 1000 and 1000a, respectively for extracting defect depth information according to some embodiments of the present inventive concept.

FIG. 5 is a block diagram of the image processor circuit 200 of the apparatus 1000 or 1000a for extracting defect depth information according to some embodiments of the present inventive concept.

FIG. 6 is a diagram explaining a calculation of a modification range of a focus position in an apparatus for extracting defect depth information according to some embodiments of the present inventive concept.

FIGS. 7A and 7B are schematic diagrams illustrating an operation of varying a focus by mechanically adjusting a lens position and a position of an inspection object in an apparatus for extracting defect depth information according to some embodiments of the present inventive concept.

FIG. 8 is a schematic diagram illustrating variable focus scanning performed by adjusting a light wavelength in an apparatus for extracting defect depth information according to some embodiments of the present inventive concept.

FIG. 9A is a cross-sectional view illustrating a semiconductor device having a defect, and FIG. 9B provides optical intensity images of the semiconductor device of FIG. 9A according to different wavelengths of a light.

FIG. 10 is a diagram illustrating variable focus scanning performed by adjusting an optical path in an apparatus for extracting defect depth information according to some embodiments of the present inventive concept.

FIG. 11 is a diagram explaining a calculation of how much a focus position is modifiable by varying an optical path.

FIG. 12 is a schematic diagram illustrating an acousto-optic tunable filter (AOTF) used to adjust a light wavelength or a light path described with reference to FIG. 8 or FIG. 10.

FIG. 13 is a perspective view illustrating a semiconductor device including a defect D0.

FIGS. 14A through 14D are cross-sectional views illustrating the semiconductor device of FIG. 13 according to particle depths.

FIGS. 15A through 15D are photographic optical intensity images of respective ones of FIGS. 14A through 14D obtained using a variable focus scanning method according to some embodiments of the present inventive concept.

FIGS. 16A through 16D are optical intensity profiles of respective ones of FIGS. 14A through 14D according to various focus positions in a depth direction (z-axis direction) at a x-axis value and derivative optical intensity profiles of the respective optical intensity profiles relative to the depth direction.

FIG. 17 is a perspective view of a semiconductor device including a bridge defect.

FIGS. 18A through 18D are cross-sectional views illustrating the semiconductor device of FIG. 17 according to bridge depths.

FIGS. 19A through 19D are photographic optical intensity images of the respective cross-sectional views in FIGS. 18A through 18D obtained using a variable focus scanning method according some embodiments of the present inventive concept.

FIGS. 20A through 20D are optical intensity profiles of respective cross-sectional views in FIGS. 18A through 18D according to focus positions in a depth direction (z-axis direction) at a x-axis value and derivative optical intensity profiles of the respective optical intensity profiles relative to the depth direction.

FIG. 21A provides optical images of a vertical NAND (VNAND) device from a plan view according to defect positions, and FIG. 21B provides vertical cross-sectional images of a VNAND device including a defect.

FIGS. 22A through 22D are photographic optical intensity images (reference images) obtained by using a variable focus scanning method at a predetermined y-axis value where no defect exists on a x-y plane.

FIGS. 23A through 23D are photographic optical intensity images (defect images) obtained by using a variable focus scanning method at a predetermined y-axis value where a defect exists on a x-y plane.

FIGS. 24A through 24D are photographic images of difference images between the reference images of FIGS. 22A through 22D and the respective defect images of FIGS. 23A through 23D.

FIGS. 25A, 26A, 27A and 28A are graphs showing optical intensity profiles at a predetermined defect point on a x-y plane (a defect signal profile) and optical intensity profiles at another predetermined point different from the defect point (a reference signal profile). FIGS. 25B, 26B, 27B and 28B are difference signal profiles between the defect signal profiles and the respective reference signal profiles.

FIG. 29 is a graph showing the difference signal profiles of FIGS. 25B, 26B, 27B, and 28B.

FIG. 30A is a signal waveform diagram for explaining an interferogram analysis as a signal analyzing method, and FIG. 30B shows a reference image (a) and a defect image (b) for explaining a mean square error (MSE) analysis as a signal analyzing method.

FIG. 31 is a flowchart illustrating a method of extracting defect depth information according to some embodiments of the present inventive concept.

FIG. 32 is a flowchart illustrating a method of improving semiconductor device manufacturing processes by using defect depth information according to some embodiments of the present inventive concept.

### DETAILED DESCRIPTION

Example embodiments are described below with reference to the accompanying drawings. Many different forms and embodiments are possible without deviating from the spirit and teachings of this disclosure and so the disclosure should not be construed as limited to the example embodiments set forth herein. Rather, these example embodiments are provided so that this disclosure will be thorough and complete, and will convey the scope of the disclosure to those skilled in the art. In the drawings, the sizes and relative sizes of layers and regions may be exaggerated for clarity.

It will be understood that when an element is referred to as being “connected” or “on” another element, it can be directly connected or on the other element, or intervening elements may also be present. In contrast, when an element is referred to as being “directly connected” or “directly on,” another element, there are no intervening elements present. Like reference numerals refer to like elements throughout. The terms used herein are for illustrative purpose of the present inventive concept only and should not be construed to limit the meaning or the scope of the present inventive concept as described in the claims.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein may be interpreted accordingly.

Expressions such as “at least one of,” when preceding a list of elements, modify the entire list of elements and do not modify the individual elements of the list.

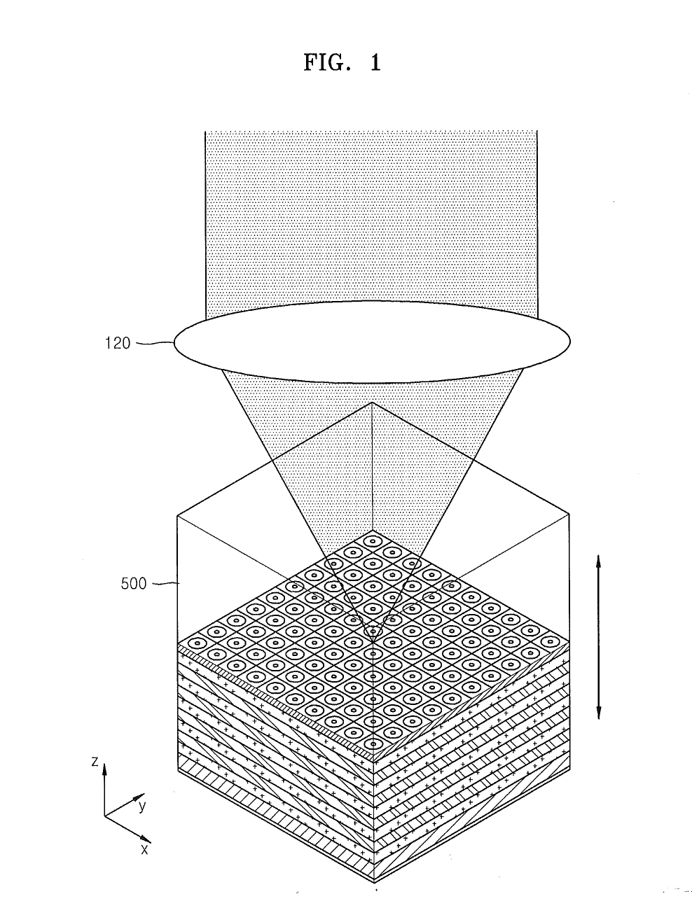

FIG. 1 is a diagram illustrating variable focus scanning performed by varying a focus position of an optical microscope of an apparatus for extracting defect depth information according to some embodiments of the present inventive concept.

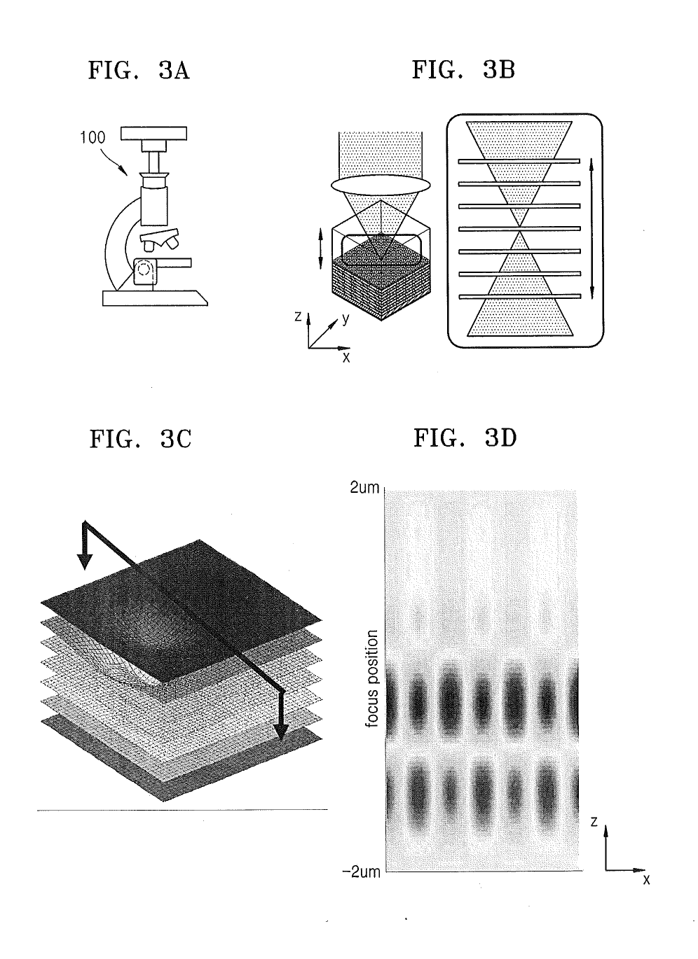

Referring to FIG. 1, an apparatus for extracting defect depth information according to some embodiments of the present inventive concept performs a variable focus scanning method in which scanning may be performed by varying a focus position. For example, as illustrated in FIG. 1, the variable focus scanning method may perform scanning by varying a focus position in a depth direction (z-axis direction) with respect to an inspection object 500, as represented by an arrow. In some embodiments, the variable focus scanning method may perform by vertically moving a lens 120 for converging light in an optical microscope 100 as represented by an arrow in FIG. 3B.

In detail, when a surface of a semiconductor device, the inspection object 500, or a predetermined surface of the semiconductor device is defined as an in-focus position with a correct focus, the variable focus scanning method may refer to performing scanning by varying a focus position within a range of ±several μm with respect to the in-focus position. Scanning may be performed in a predetermined direction on an x-y plane that is substantially perpendicular to the z-axis, for example, in an x-axis direction, and then other portion of the inspection object 500 may be set as a next focus position to perform scanning again along the x-axis direction.

In order to reduce the time for variable focus scanning, scanning may be performed by moving a focus position by predetermined units of distance from a minimum focus position to a maximum focus position or from a maximum focus position to a minimum focus position. The variable focus scanning may be performed not only with respect to a fixed y-axis value but also on a x-y plane. The variable focus scanning may be performed first with respect to a predetermined y-axis value, and then with respect to a next y-axis value to scan a x-y plane.

When performing variable focus scanning along the x-y plane as described above, the scanning time may considerably increase. Accordingly, by using an apparatus for extracting defect depth information according to some embodiments of the present inventive concept, scanning may be performed on the x-y plane first after fixing a focus position to an in-focus position (hereinafter, “typical scanning), thereby quickly detecting a defect position on the x-y plane. After a defect position is found on the x-y plane, a y-axis value of the defect position may be fixed and then the above-described variable focus scanning may be performed again.

As will be described later in detail with reference to FIG. 3, the apparatus for extracting defect depth information according to some embodiments of the present inventive concept may be used to obtaining defect depth information by using the above-described variable focus scanning. Accordingly, as described above, by combining typical scanning and the above-described variable focus scanning, a defect position and defect depth information may be obtained quickly and accurately.

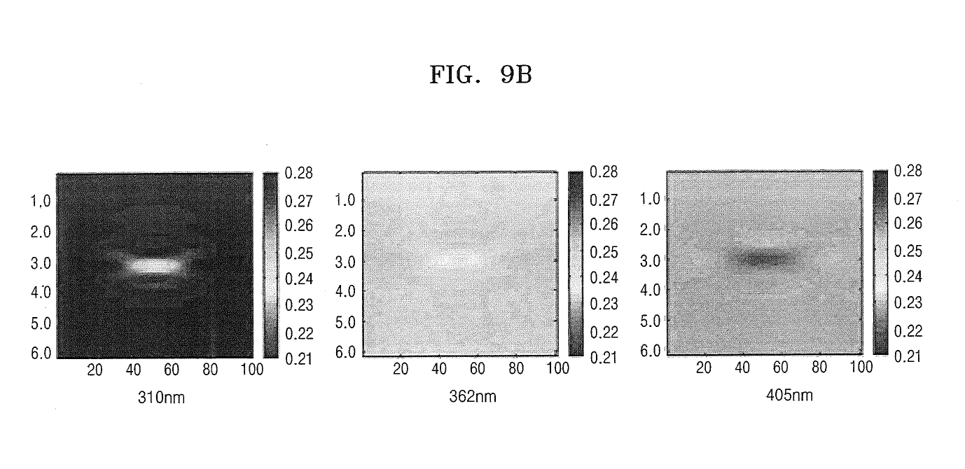

Meanwhile, although modifying a focus position by moving the lens 120 has been described above, a focus position may also be modified by moving the inspection object 500, adjusting a light wavelength, adjusting a light path, or the like. Modification of a focus position will be described with reference to FIGS. 7A, 7B, 8, 9A, 9B, 10, 11, and 12.

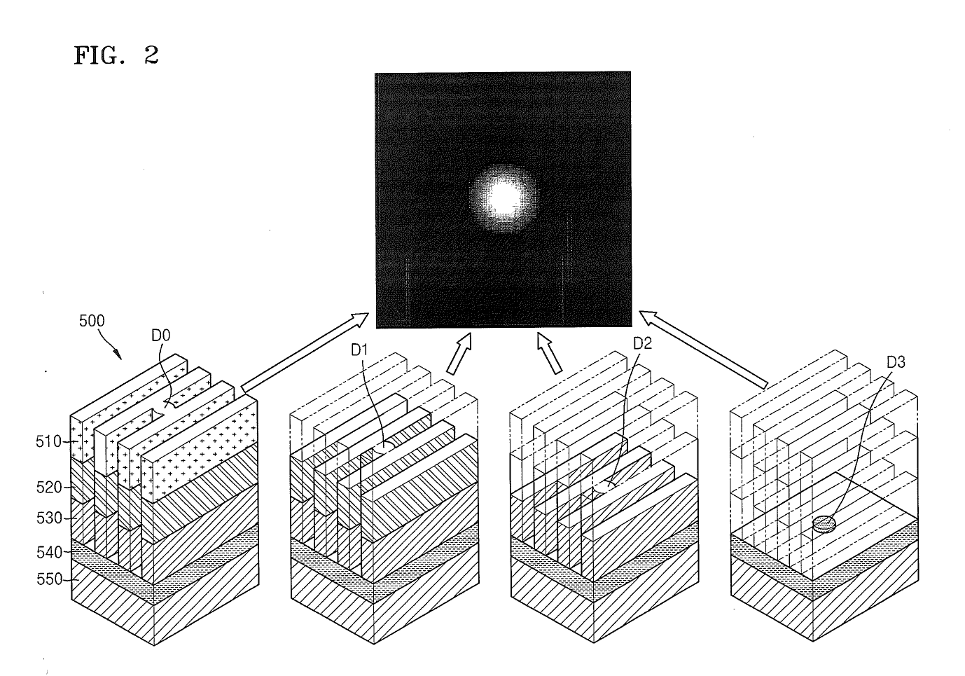

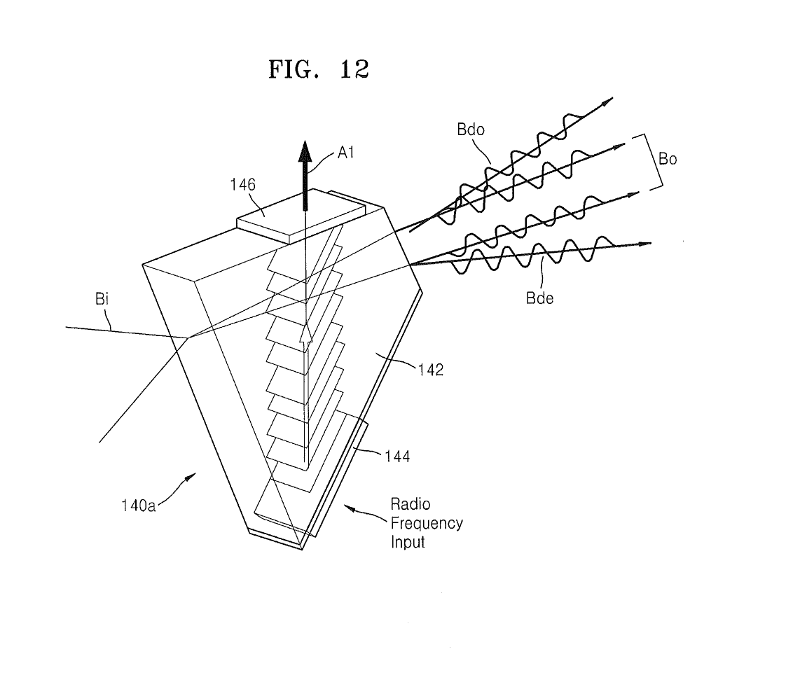

FIG. 2 provides perspective views of four semiconductor devices including respective defects at different depths and an optical signal image of the four semiconductor devices obtained using a fixed focus scanning. For the following, FIG. 2 is rotated by 90° in the counter-clockwise direction. The same applies to FIGS. 9B, 15, 16, 19, 20, 21A, and 21B.

Referring to the lower portion of FIG. 2, defects such as particles or voids may exist on a surface of the inspection object 500 such as a semiconductor device or in inner layers of the inspection object 500. A defect D0 may be on a surface of a semiconductor, that is, on a surface of an uppermost layer 510. A defect D1 may be on a first inner layer 520, a defect D2 may be on a second inner layer 530, and a defect D3 may be in a third inner layer 540. The reference numeral 550 denotes a substrate of the semiconductor device.

Even though the defects are at different depths, if those defects are at identical positions on a x-y plane, almost the same optical signals may be obtained by using fixed focus scanning, that is, scanning performed with a fixed focus position. As provided in FIG. 2, the four semiconductor devices including respective defects at different depths provide almost same optical signal image shown in the upper portion of FIG. 2 when the typical scanning with a fixed focus position is used.

In other words, when fixed focus scanning is performed, only lateral information of a defect associated with the x-y plane may be obtained and depth information of the defect may not be obtained. However, when a focus position is fixed, a lateral position of a defect may be found relatively quickly on the x-y plane. Accordingly, a lateral position of a defect may be found first by applying fixed focus scanning, and then defect depth information may be obtained quickly and accurately by performing variable focus scanning at a point or a coordinate where the defect is located.

FIGS. 3A through 3D are drawings illustrating an operation of obtaining defect depth information using a variable focus scanning method with an apparatus according to some embodiments of the present inventive concept.

Referring to FIG. 3A, an optical microscope 100 which is capable of modifying a focus position may be used. Modification of a focus position will be further described in detail later with reference to FIGS. 7A, 7B, 8, 9A, 9B, 10, 11, and 12. The optical microscope 100 may include a digital camera that is capable of capturing light reflected from an inspection object and performing digital signal process thereon. The optical microscope 100 may be not only a typical optical microscope but also may be a conceptual apparatus that includes any type of sensor or detector for inspecting an object by using light.

Referring to FIG. 3B, variable focus scanning is performed on an inspection object by varying a focus position in a depth direction. The depth direction may be a z-axis direction, and a scanning direction may be an x-axis direction. The variable focus scanning may be performed with respect to a single fixed y-axis value corresponding to a defect position. In some embodiments, variable focus scanning may also be performed with respect to at least two y-axis values.

Referring to FIG. 3C, a two-dimensional (2D) optical image may be obtained according to each focus positions. The 2D optical image may be a digital image obtained by using digital signal processing. The digital image may be obtained by using a digital camera included in the optical microscope 100. The digital image may be transmitted to an analysis computer on which digital signal processing algorithms are installed.

Meanwhile, an optical intensity profile may be extracted from each of 2D optical images according to focus positions with respect to a predetermined fixed y-axis value as represented by an arrow. The optical intensity profile may be extracted from the 2D optical images by using a predetermined algorithm installed in a computer.

Referring to FIG. 3D, an optical intensity image according to a focus position is generated by integrating the optical intensity profiles. An optical intensity image according to a focus position may be implemented by allocating colors to the optical intensity on the x-z plane. The allocated colors are merely in relative numerical values corresponding to optical intensities and do not represent accurate values of optical intensities.

Scanning may be performed along the x-axis with interval of several μm with respect to x=0 defined as a defect position. The z-axis is a direction corresponding to modified focus positions, that is, a focus depth direction, and scanning may be performed along the z-axis with interval of several gm, for example, 2 μm, with respect to z=0 defined as an in-focus position. The in-focus position may be set arbitrarily. For example, a location where a defect is or a surface of an inspection object may be set as an in-focus position. It may be difficult to detect a location where a defect is, therefore a surface of the inspection object may be set as an in-focus position.

The obtained optical intensity images may be compared with comparison images stored in a library database. The comparison images stored in the library database may be classified according to various standards such as types of an inspection object, positions of defects on an x-y plane, and defect depths. When a comparison image that matches the obtained optical intensity images, hereinafter “matching comparison image,” exists in the library database, defect depth information of the inspection object may be obtained based on information about a defect depth of the matching comparison image.

The comparison images stored in the library database may be data obtained by performing simulations or experiments on an inspection object. Optical intensity images obtained by using the variable focus scanning described above may also be stored in the library database and used as comparison images. Also, a vertical cross-sectional scanning electron microscope (SEM) analysis or a vertical cross-sectional transmission electron microscope (TEM) analysis may be performed to analyze an inspection object, and new comparison images may be generated or existing comparison images may be updated to reflect the results of the SEM or TEM analysis. For example, if there is a large difference between data obtained by using simulations or the like and the results of the SEM or TEM analysis, data obtained by the simulations or the like may be discarded or modified.

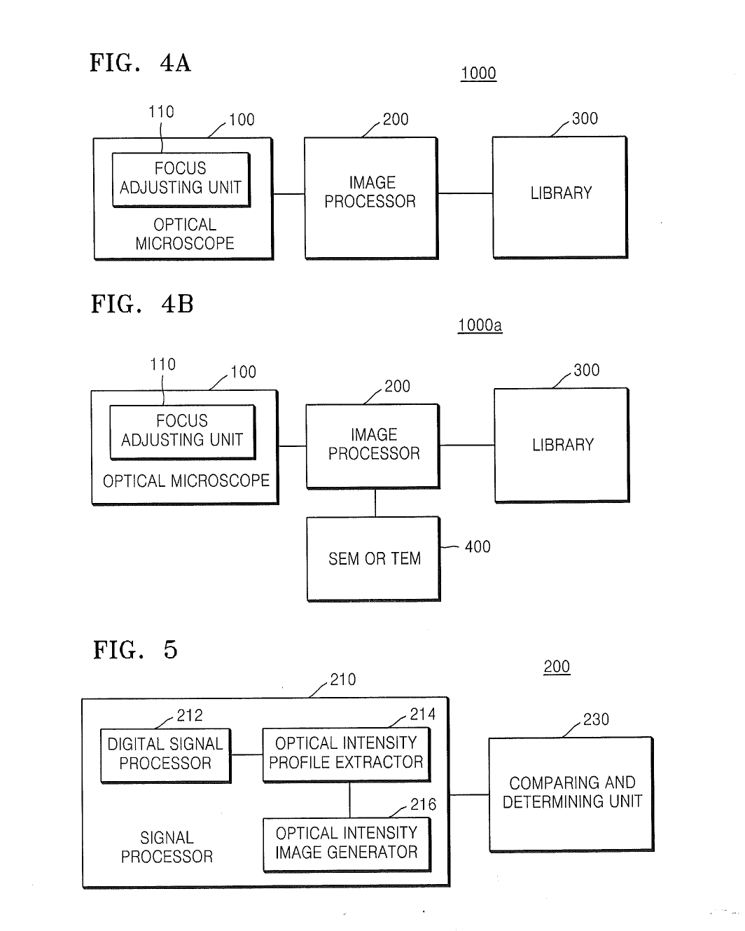

FIGS. 4A and 4B are block diagrams illustrating apparatuses 1000 and 1000a, respectively for extracting defect depth information according to some embodiments of the present inventive concept. Referring to FIG. 4A, the apparatus 1000 for extracting defect depth information may include an optical microscope 100, an image processor circuit 200, and a library database 300.

The optical microscope 100 is an optical device for inspecting an object by magnifying and observing the object by using light, and may be almost similar to typical optical microscopes having a well-known structure or operating principle. However, in the apparatus 1000 for extracting defect depth information, the optical microscope 100 may include a focus adjusting assembly 110 that is capable of modifying a focus position.

The focus adjusting assembly 110 may modify a focus position with predetermined interval by using various methods. For example, the focus adjusting assembly 110 may modify a focus position by modifying a position of a lens along a z-axis that converges light onto an inspection object. Also, the focus adjusting assembly 110 may modify a focus position by modifying a position of a stage along the z-axis on which an inspection object is placed. Meanwhile, the focus adjusting assembly 110 may modify a focus position by modifying a wavelength of light of a light source or a light path of light of a light source. Modification of a focus by using the focus adjusting assembly 110 will be described in further detail with reference to FIGS. 7A, 7B, 8, 9A, 9B, 10, 11, and 12.

The above-described variable focus scanning method may be performed by using the optical microscope 100 including the focus adjusting assembly 110. Accordingly, a plurality of 2D optical images according to respective focus positions may be obtained.

The image processor circuit 200 integrally processes the plurality of 2D images received from the optical microscope 100 to generate optical intensity images, and compares the optical intensity images with comparison images stored in the library database to thereby extract depth information of a defect. The image processor circuit 200 may be a digital camera attached to the optical microscope 100 or a computer in which digital signal processing algorithms are installed. That is, any device capable of performing digital signal processing on the 2D images obtained by using the optical microscope 100 and analyzing the 2D images may be included in the image processor circuit 200.

Meanwhile, by using various signal processing algorithms, the image processor circuit 200 may generate or extract not only optical intensity images but also various defect-related data. For example, the image processor circuit 200 may extract at least one of an optical intensity profile according to a depth direction of a focus, that is, according to a focus position at a predetermined defect point on a x-y plane perpendicular to a z-axis, a differentiation signal profile of a z-axis with respect to the optical intensity profile, a difference image between an optical intensity image corresponding to a y-axis value where a defect exists (a defect image) and the optical intensity image corresponding to a predetermined y-axis value where no defect exists(a reference image), on the x-y plane, and a difference signal profile between the optical intensity profile at a predetermined defect point on the x-y plane (a defect signal profile) and the optical intensity profile at another point that is different from the defect point(a reference signal profile).

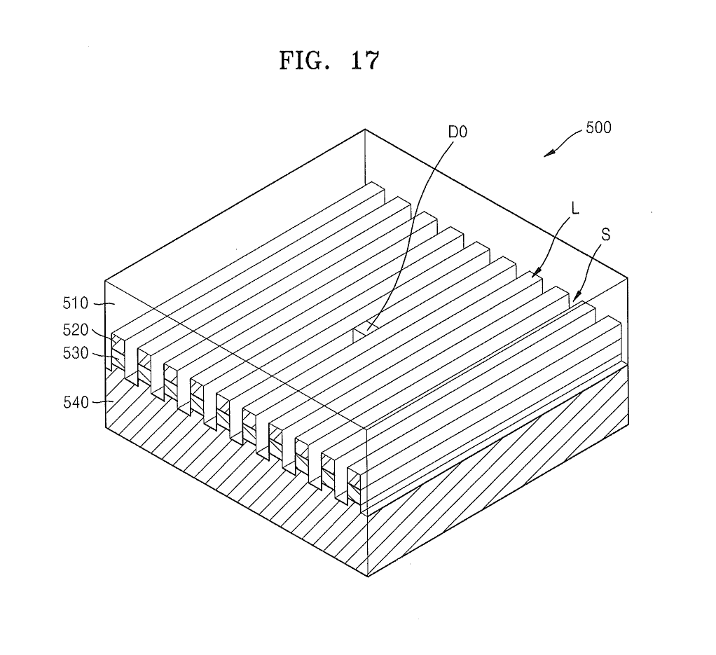

The optical intensity profile, the differentiation signal profile, the reference image, the defect image, the difference image, the defect signal profile, the reference signal profile, and the difference signal profile will be described in further detail with reference to FIGS. 13 through 29.

The library database 300 stores a plurality of optical intensity images obtained by simulations or experiments as comparison images, and provide the comparison images to the image processor circuit 200 in order to extract defect depth information. The library database 300 may store not only comparison images but also various defect-related data. For example, comparison data related to an optical intensity profile, a differentiation signal profile, a reference image, a defect image, a difference image, a defect signal profile, a reference signal profile, and a difference signal profile extracted by using the image processor circuit 200 may be stored in the library database 300.

Referring to FIG. 4B, the apparatus 1000a for extracting defect depth information according to some embodiments of the present inventive concept may further include a SEM or TEM 400, A SEM is a device that narrowly converges an electronic ray emitted from an electron source (electron gun) by an electronic lens to irradiate the electronic ray through two-dimensional scanning onto a sample, and detects secondary electrons emitted out of a surface of the sample and forms an image of a concave-convex structure on the surface of the sample. A TEM is a device in which heat electrons are emitted from a filament as an electron source, and accelerated at a relatively high speed to be converged by an electronic lens, and the converged electron ray is transmitted through a sample to be magnified by an object lens and a projection lens (electronic lens), and the electronic ray is formed into an image by using a phosphorescent plate.

As described above, the SEM or TEM 400 may perform inspection by cutting a sample such as an inspection object into thin slices so that the inspection object is destructed and in-line monitoring may not be performed accordingly. However, by using the SEM or TEM 400, a vertical structure of an inspection object and depth information of a defect according to the vertical structure of the inspection object may be analyzed relatively accurately. Thus, by reflecting analysis results of the SEM or TEM 400 on optical intensity images or other various defect-related data, data about accurate defect depths may be generated and/or used for updating data. That is, various defect-related data including analysis results of the SEM or TEM 400 may be stored in the library database 300 as comparison data, and may be used in order to extract defect depth information.

Although the SEM or TEM 400 has been described above, other inspection devices that are capable of performing a physical destructive test may be used instead of the SEM or TEM 400 in some embodiments of the present inventive concept. For example, a focused ion beam (FIB) device or a secondary ion mass spectroscopy (SIMS) may be used in place of the SEM or TEM 400.

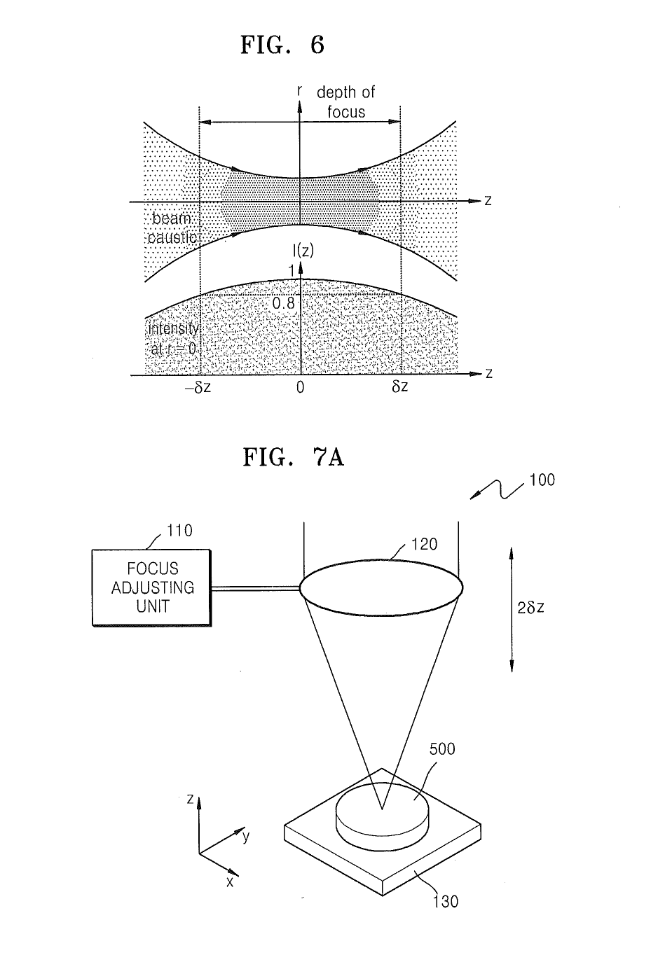

FIG. 5 is a block diagram of the image processor circuit 200 of the apparatus 1000 or 1000a for extracting defect depth information according to some embodiments of the present inventive concept. Referring to FIG. 5, the image processor circuit 200 may include a signal processor circuit 210 and a comparing and determining unit 230.

The signal processor circuit 210 may integrally process a plurality of images received from the optical microscope 100 to generate optical intensity images. The signal processor circuit 210 may include a digital signal processor circuit 212, an optical intensity profile extractor circuit 214, and an optical intensity image generator circuit 216.

The digital signal processor circuit 212 may convert a 2D image received from the optical microscope 100, to a digital signal. Accordingly, the digital signal processor circuit 212 may convert a 2D image to a 2D digital image. The digital signal processor circuit 212 may be embedded in a digital camera.

The optical intensity profile extractor circuit 214 may extract an optical intensity profile from the digital signal provided by the digital signal processor circuit 212. That is, the optical intensity profile extractor circuit 214 may extract a signal profile according to an optical intensity from a 2D digital image as illustrated in FIG. 3C. The optical intensity profile extractor circuit 214 may extract an optical intensity profile at a defect point according to focus positions or within a predetermined x-axis section according to focus positions.

The optical intensity image generator circuit 216 may generate an optical intensity image on an x-z plane by integrating the optical intensity profiles according to the focus positions. In detail, the optical intensity images may be implemented by allocating colors corresponding to optical intensities on the x-z plane. An x-axis may be a direction in which scanning is performed with interval of several μm with respect to x=0 defined as a defect position. A z-axis may be a direction corresponding to modified focus positions, and scanning along the z-axis may be performed with interval of several on with respect to z=0 as an in-line focus position.

Meanwhile, the optical intensity image generator circuit 216 may generate an optical intensity image according to y-axis values. Accordingly, the optical intensity image generator circuit 216 may generate an optical intensity image corresponding to a y-axis values at which a defect exists and set the optical intensity image as a defect image, and generate an optical intensity image corresponding to another predetermined y-axis value at which no defect exists and set the same as a reference image. Also, the optical intensity image generator circuit 216 may generate a difference image between the defect image and the reference image.

The comparing and determining circuit 230 may extract defect depth information by comparing optical intensity images obtained by using a variable focus scanning method and comparison images stored in the library database 300. In detail, the comparing and determining circuit 230 may compare optical intensity images with a plurality of comparison images and find a matching comparison image. When a matching comparison image is found, defect depth information of an inspection object may be obtained based on defect depth information of the corresponding matching comparison image.

The comparing and determining circuit 230 may also obtain defect depth information of an inspection object by comparing not only an optical intensity image but also other defect-related data with the comparison data stored in the library database 300.

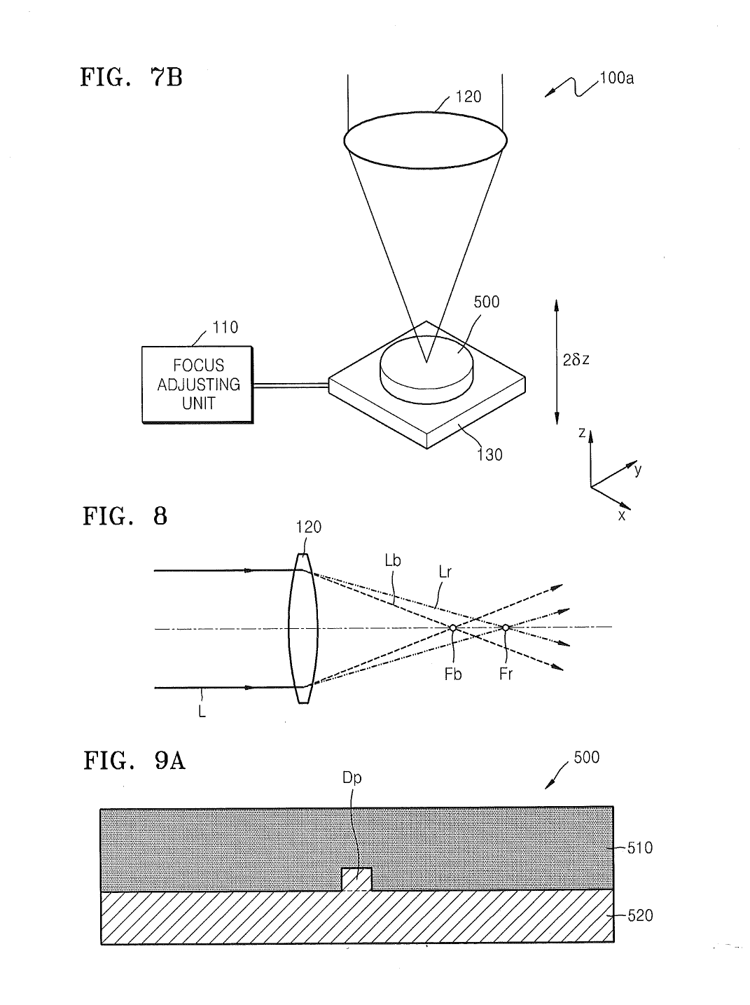

FIG. 6 is a diagram explaining a calculation of a modification range of a focus position in an apparatus for extracting defect depth information according to some embodiments of the present inventive concept.

Referring to FIG. 6, a range of a focus position may be set according to a structure of an inspection object. However, if a focus position exceedingly deviates from an in-focus position, an image obtained at the focus position may not be in a proper state, and it takes long time to perform the entire variable focus scanning. Accordingly, an appropriate modification range of a focus position may be set based on predetermined standards.

FIG. 6 shows how a depth of focus (2δz) may be defined and a z-axis denotes a focus position, r denotes a distance from a center on a lateral cross-section of a focus, and I(z) denotes an optical intensity value according to z. When an optical intensity value at a point z=0, that is at an in-focus point, is set to 1, a distance between points (±δz) corresponding to about 80% of the optical intensity value may be defined as a depth of focus.

Meanwhile, Formula (1) for a depth of focus may be approximately provided as follows:

δz≈λ/2 NA² Formula (1),

where λ is a light wavelength, and NA denotes a numerical aperture.

When λ is 250 nm to 450 nm, and NA is 0.5 to 0.9, the depth of focus may have a value of 2δz≈300 nm to 550 nm (NA=0.9) or 2δz≈1000 nm to 1800 nm (NA=0.5).

Accordingly, scanning data corresponding to a focus position in a range of about −1 μm to about 1 μm may be used as data for inspection analysis. A modification range of a focus position may be set based on the above-described concept of depth of focus in an apparatus for extracting defect depth information according to some embodiments of the present inventive concept. For example, a modification range of a focus position may be set as a depth of focus in an apparatus for extracting defect depth information according to some embodiments of the present inventive concept. Accordingly, when a wavelength of an optical microscope used is 450 nm and a numerical aperture is 0.5, a modification range of a focus position may be about ±1 μm.

For example, if an inspection apparatus can change a focus position accurately with interval of about 40 nm, a modification interval of a focus position may be set to 40 nm in variable focus scanning. When scanning is to be performed through a distance of 2 μm, since 2 μm/40 nm=50 and thus variable focus scanning may be performed at a defect point in 100 times. As a result, in the apparatus for extracting defect depth information according to some embodiments of the present inventive concept, analysis of a defect source may also be performed with respect to layers having a thickness of several tens of nm.

Alternatively, interval of modifying a focus position may also be set to about 40 nm or greater in consideration of a structure of an inspection object or a time period of inspection.

FIGS. 7A and 7B are schematic diagrams illustrating an operation of varying a focus by mechanically adjusting a lens position and a position of an inspection object in an apparatus for extracting defect depth information according to some embodiments of the present inventive concept.

Referring to FIG. 7A, an optical microscope 100 in the apparatus may move a lens 120 along a z-axis direction in a predetermined range using a focus adjusting assembly 110 to modify a focus position. The z-axis direction may be a direction of depth of focus. For example, the predetermined range may be a depth of focus (2δz) as described above with reference to FIG. 6.

The focus adjusting assembly 110 may move the lens 120 along the z-axis direction using a mechanical method. In the mechanical method, the lens 120 may be moved along the z-axis direction by using electricity or by hand based on the structure of the optical microscope 100.

Referring to FIG. 7B, in the apparatus for extracting defect depth information according to some embodiments of the present inventive concept, an optical microscope 100a may move a stage 130 on which an inspection object 500 is placed by using a focus adjusting assembly 110 along a z-axis direction in a predetermined range, that is, in a direction of depth of focus. The predetermined range may be depth of focus (2δz). A focus position with respect to the inspection object 500 may be modified by movement of the stage 130 in the z-axis direction.

The focus adjusting assembly may move the stage 130 along the z-axis direction by using a mechanical method. In the mechanical method, the stage 130 may be moved based on the structure of the optical microscope 100 along the z-axis direction by using electricity or by hand.

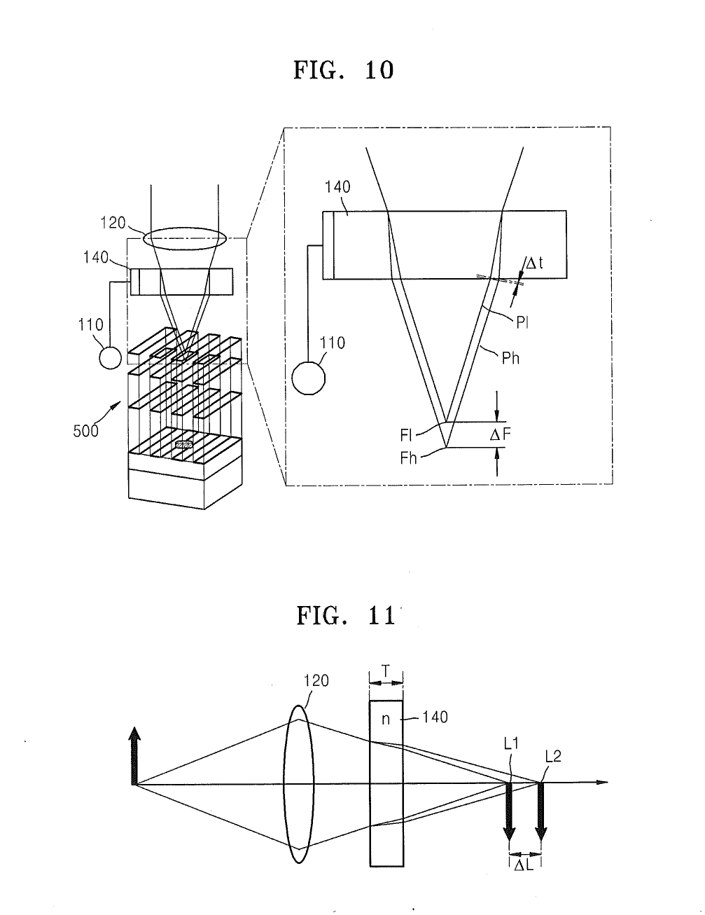

FIG. 8 is a schematic diagram illustrating variable focus scanning performed by adjusting a light wavelength in an apparatus for extracting defect depth information according to some embodiments of the present inventive concept.

Referring to FIG. 8, a refractive index of light varies according to wavelength thereof. That is, a refractive index of a predetermined medium may increase when a wavelength gets shorter and may decrease when the wavelength gets longer. Thus, as illustrated in FIG. 8, a focus position Fb of blue light Lb is shorter than a focus position Fr of red light Lr with respect to the lens 120 as a predetermined medium.

Incident light L may be white light and it may be separated into various colors after passing through a prism or a lens because a refractive index of the prism or lens varies according to the wavelength of light.

In the apparatus for extracting defect depth information according to some embodiments of the present inventive concept, variable focus scanning may be performed based on the principle that a refractive index of light varies according to wavelengths of the light. That is, a focus position may be modified by varying a light wavelength while maintaining a position of the lens 120 or the stage 130.

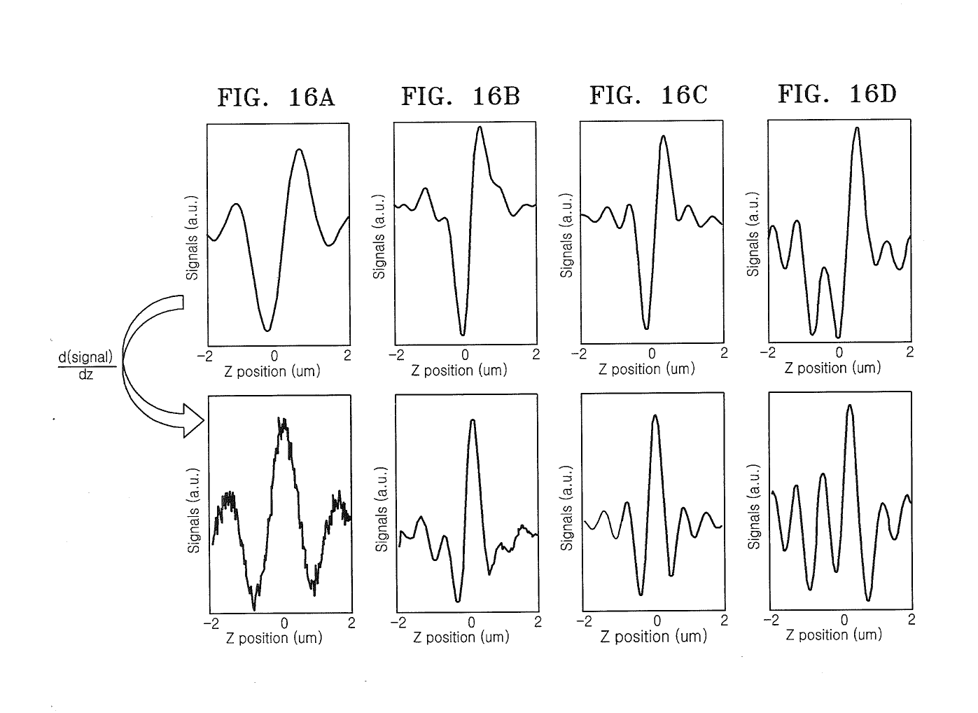

Examples of methods of modifying a light wavelength include a method of using an optical filter circuit such as an acousto-optic tunable filter (AOTF) or a method of using a wavelength-tunable laser as a light source. The AOTF may refer to a filter that selectively outputs only light of a predetermined wavelength from incident white light. The structure or principle of the AOTF will be described in further detail with reference to FIG. 12.

A focus position as described above may be modified by placing the AOTF in front of the lens 120 and modifying a wavelength of output light by applying an appropriate driving frequency.

Meanwhile, a wavelength tunable laser may refer to laser which is capable of varying an oscillation frequency by controlling a driving current or a driving frequency. A variation in an oscillation frequency may immediately indicate a variation in a wavelength of light that is to be output. When a wavelength tunable laser is used as a light source of an optical microscope, a focus position may be easily modified by modifying an oscillation frequency of the wavelength tunable laser.

Meanwhile, a variation in a wavelength of the AOTF and the wavelength tunable laser may be performed by using the focus adjusting assembly 110. In the apparatus for extracting defect depth information according to some embodiments of the present inventive concept, the focus adjusting assembly 110 may be, for example, a driving driver that may modify an output wavelength by applying a current or a frequency to the AOTF or the wavelength tunable laser.

As described above, in the apparatus for extracting defect depth information according to some embodiments of the present inventive concept, an output wavelength may be varied by applying a current or a frequency to an optical filter circuit or a wavelength tunable laser, and the output wavelength may vary within several microseconds (ms) by applying a current or a frequency may be conducted. Accordingly, a focus position may be modified more quickly than when using the mechanical method described above, and thus, rapid, variable focus scanning may be performed.

FIG. 9A is a cross-sectional view illustrating a semiconductor device having a defect, and FIG. 9B provides optical intensity images of the semiconductor device of FIG. 9A according to different wavelengths of a light.

Referring to FIGS. 9A and 9B, FIG. 9A illustrates a defect Dp such as a particle on an inner layer 520 of an inspection object 500, and FIG. 9B shows optical intensity images obtained by using focus scanning with varying the light wavelengths. Specifically, the first from the left is a scanning image obtained by using a light having a wavelength of 310 nm, the middle image is obtained by obtained by using a light having a wavelength of 362 nm, and the last from the left is obtained by obtained by using a light having a wavelength of 405 nm. The scanning images are obtained by performing fixed focus scanning, and the horizontal and vertical axes of graphs of FIG. 9B may respectively denote an x-axis and a y-axis.

As seen in FIG. 9B, different scanning images are obtained according to the different wavelengths. Accordingly, defect depth information may be obtained by comparing the scanning images obtained using the different wavelengths with the scanning images stored in a library database obtained using the different wavelengths. Meanwhile, when a wavelength is modified, a focus position is also modified as described above. Thus, the three scanning images illustrated in FIG. 9B may respectively correspond to different focus positions. Consequently, an optical intensity image similar to FIG. 3D may be obtained by selecting a fixed, single y-axis value or y-axis values in a predetermined range and placing an optical intensity image corresponding to the y-axis value according to a focus position along a z-axis.

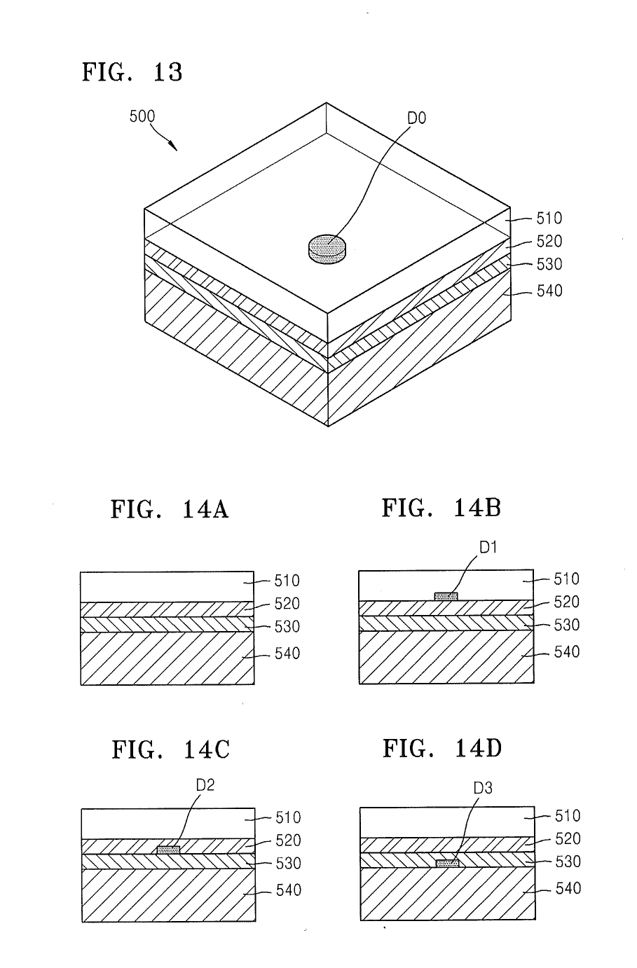

FIG. 10 is a diagram illustrating variable focus scanning performed by adjusting an optical path in an apparatus for extracting defect depth information according to some embodiments of the present inventive concept.

Referring to FIG. 10, a focus position may be modified by varying a light path. For example, light may be set to proceed from a lens 120 to pass through a plate 140, and here, a focus position may be modified by modifying a refractive index of the plate 140 by applying a current or frequency to the plate 140. Thus, a focus position may be modified by modifying a path of light that passes through the plate 140.

As illustrated in the right expanded portion of FIG. 10, incident light may have various refraction angles according to the refractive index of the plate 140. In other words, when a difference between refractive indices of an air and the plate 140 where light is incident increases, a refraction angle also increases and a light path is modified accordingly, and thus, a focus position may be far from the plate 140.

In detail, when the refractive index of the plate 140 increases from a low refractive index Pl to a high refractive index Ph, a refraction angle of light is increased (a refraction angle with respect to a normal of an incident surface is decreased), and accordingly, a light path may extend such that a focus position Fh may be far from the plate 140. On the other hand, when the refractive index of the plate 140 decreases from the high refractive index Ph to the low refractive index Pl, a refraction angle of light is decreased (a refraction angle with respect to a normal of an incident surface is increased), and accordingly, a focus position Fl may get closer to the plate 140 as a light path is shortened. Accordingly, there may be a difference (ΔF) between the focus position Fh corresponding to the high refractive index Ph of the plate 140 and the focus position Fl corresponding to the low refractive index Pl of the plate 140. On the other hand, light paths in the plate 140 may also be varied, and as illustrated in FIG. 10, a light path Pl corresponding to the low refractive index may have a longer range than a light path Ph corresponding to the high refractive index in the plate 140.

In the apparatus for extracting defect depth information according to some embodiments of the present inventive concept, a focus position may be modified by modifying a light path. Meanwhile, modification of a light path may be performed by using the plate 140 whose refractive index is varied upon application of a current (a frequency). Also, a refractive index of the plate 140 may be varied by applying a current (a frequency) to the plate 140 by using the focus adjusting assembly 110 such as a driving driver. The varying of the refractive index by applying a current (a frequency) or modification of a light path according to the variation in the refractive index may be performed within several milliseconds. Accordingly, in a similar manner as to the method of modifying a wavelength, a focus position may be quickly modified in the apparatus for extracting defect depth information according to some embodiments of the present inventive concept, thereby allowing a rapid, variable focus scanning operation.

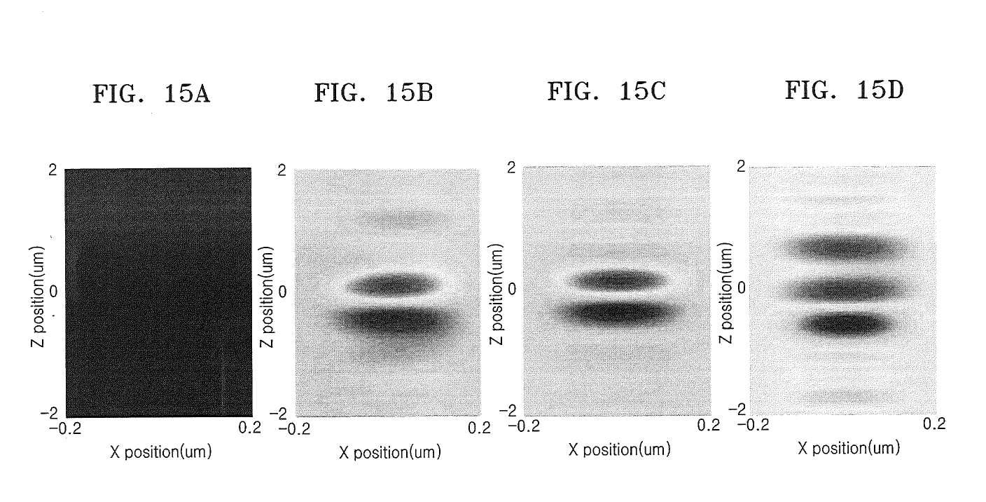

FIG. 11 is a diagram explaining a calculation of how much a focus position is modifiable by varying an optical path.

Referring to FIG. 11, an arrow in left side may denote an object, and arrows in right side may denote reverse images formed at a focus position. Meanwhile, when a refractive index of the plate 140 is n and a thickness thereof is T, a focal distance L may be expressed by Formula (2) below:

L=(n−1)T/n Formula (2)

When a first refractive index n1 is 4.0; a second refractive index n2 is 4.01; and a thickness of the plate 140 is 5,000 μm, a focal distance L1 at the first refractive index n1 may be 3,750 μm; and a second focal distance L2 at the second refractive index n2 may be 3,762.5 μm. Accordingly, a variation (ΔL) in a focus position may be 12.5 μm.

The above calculation indicates that a variation of the refractive index of the plate 140 of about 0.01 may cause a variation in a focal distance of about 12.5 μm. In addition, as described above, the varying of the refractive index may be performed within several milliseconds. Meanwhile, by setting a modification range of a focus position to about ±2 μm, variable focus scanning may be performed based on a relatively small variation in a refractive index.

FIG. 12 is a schematic diagram illustrating an acousto-optic tunable filter (AOTF) used to adjust a light wavelength or a light path described with reference to FIG. 8 or FIG. 10.

Referring to FIG. 12, the AOTF 140a is a filter developed by using a TeO2 crystal 142 having excellent acousto-optic characteristics, which functions as a diffraction lattice for incident white rays so as to select a desired wavelength and to operate as an optical band-pass filter having a relatively narrow bandwidth. A wavelength may be selected according to a radio frequency (RF) at which a piezo-transducer 144 attached to an AO crystal (or the TeO2 crystal 142) is driven. Accordingly, light of a desired wavelength may be continuously obtained by turning a driving frequency of the AOTF 140a. Also, a crystal lattice is varied within a period of time of about 20 μs by changing an output frequency of a driving driver in order to modify a wavelength of an output beam, and thus, a wavelength variation may be conducted almost in real-time.

Here, an acoustic absorber 146 absorbs an acoustic wave, and an arrow A1 at the side of the acoustic absorber 146 may indicate an optical axis of the TeO2 crystal 142. As illustrated in FIG. 12, when focused non-polarized input light Bi is input to the AOTF 140a, the input light Bi may be separated into, for example, non-diffracted zero order beams (Bo), diffracted ordinary polarized waves (Bdo), and diffracted extraordinary polarized waves (Bde), by a traveling acoustic wave proceeding along an optical axis direction. The traveling acoustic wave may be generated via a radio frequency signal input to the piezo-transducer 144.

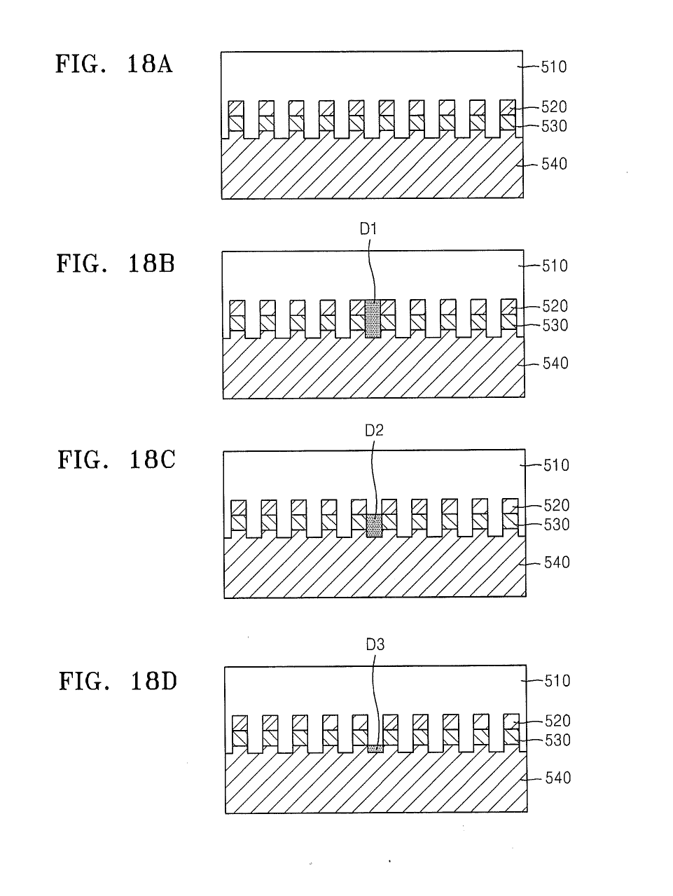

FIG. 13 is a perspective view illustrating a semiconductor device including a defect D0, and FIGS. 14A through 14D are cross-sectional views illustrating the semiconductor device of FIG. 13 according to particle depths.

Referring to FIG. 13, a defect D0 such as a particle may be in an inspection object 500 such as a semiconductor device. Although the defect D0 is illustrated on a second inner layer 520 of the semiconductor device in FIG. 13, as illustrated in FIGS. 14B through 14D, the defect D0 may also exist on any inner layer of at least one of first through third inner layers 520, 530, and 540. Also, the defect D0 may exist within the inner layers 520, 530, and 540.

For reference, the semiconductor device, which is the inspection object 500, may sequentially include an uppermost layer 510, the first inner layer 520, the second inner layer 530, and the third inner layer 540. The uppermost layer 510 may be a protection layer or a passivation layer that protects the semiconductor device. Also, the first through third inner layers 520, 530, and 540 may include a plurality of integrated circuits and wirings in the semiconductor device. Meanwhile, the third inner layer 540 may be a substrate included as a lowermost layer of the semiconductor device. However, the semiconductor device is schematically illustrated for convenience of description, and other layers may also be further disposed below the third inner layer 540. Thus, another layer below the third inner layer 540 may correspond to a substrate.

FIGS. 14A through 14D are cross-sectional views illustrating portions of the inspection object 500. In detail, FIG. 14A is a cross-sectional view of a portion which does not include a defect, and FIG. 14B is a cross-sectional view of a portion including a defect D1 on the first inner layer 520. Also, FIG. 14C is a cross-sectional view of a portion including a defect D2 on the second inner layer 530, and FIG. 14D is a cross-sectional view of a portion including a defect D3 on the third inner layer 540.

When defects exists in different layers as described above, and the defects are inspected using a typical scanning method, almost the same or similar optical signal images may be obtained as discussed above with reference to FIGS. 2A through 2D.

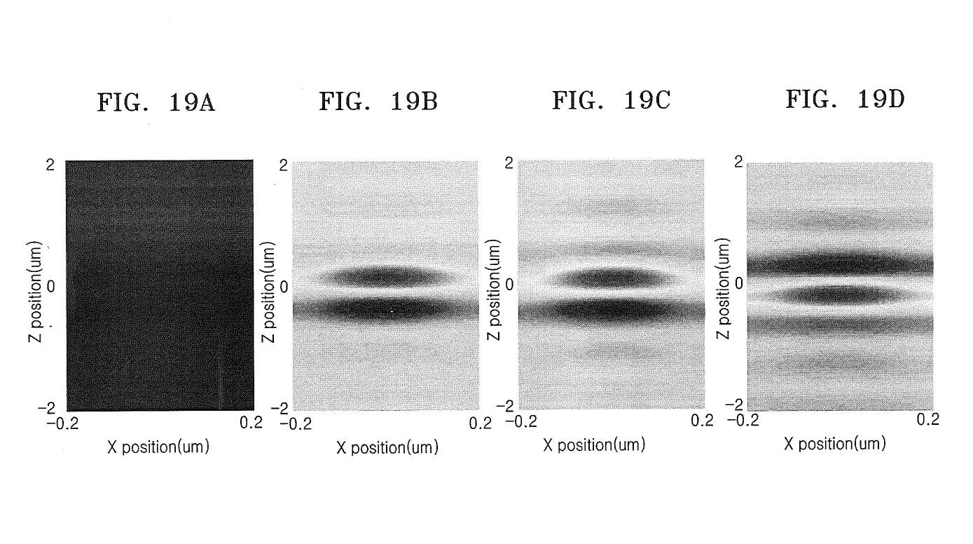

FIGS. 15A through 15D are photographic optical intensity images of respective ones of FIGS. 14A through 14D obtained using a variable focus scanning method according to some embodiments of the present inventive concept.

Referring to FIGS. 15A through 15D, first, a variable focus scanning method is applied to the cross-sections of FIGS. 14A through 14D to extract optical intensity profiles according to the respective focus positions by using digital signal processing algorithms, and then colors may be allocated according to corresponding optical intensities by integrating the optical intensity profiles so as to generate optical intensity images as illustrated in FIGS. 15A through 15D.

A z-axis indicates a position with respect to a direction of depth of focus, and z=0 may indicate an in-focus position of a focus. The in-focus position may be appropriately set in consideration of the intention of an inspector, comparison data stored in a library database, and specifications of an apparatus for extracting defect depth information. For example, an upper surface of the uppermost layer 510, that is, an upper surface of the semiconductor device may be set to an in-focus position in the current experimental example. Accordingly, it can be seen that an optical intensity abruptly varies at z=0 in optical intensity images from the second through fourth images from the left, that is, FIGS. 15B through 15D. This may be explained based on the fact that most reflection is generated on a surface of the semiconductor device. For reference, a range of modifying the focus position may be set to about ±2 μm.

Meanwhile, an x-axis is a direction in which scanning is performed in a predetermined range with respect to a predetermined fixed y-axis value at which a defect exists. For example, the predetermined range may be about ±0.2 μm.

As illustrated in FIGS. 15A through 15D, different optical intensity images may be generated according to a depth of a defect, that is, according to a z-axis position of the defect. Accordingly, the optical intensity images may be used in extracting defect depth information. For example, when optical intensity images according to respective defect depths are stored in a library database as comparison images and when an optical intensity image is generated by using variable focus scanning with respect to a predetermined semiconductor device which is the inspection object 500, if a matching comparison image is found upon comparing the generated optical intensity image with the comparison images stored in the library database, defect depth information of the matching comparison image may be obtained as defect depth information of the inspected semiconductor device.

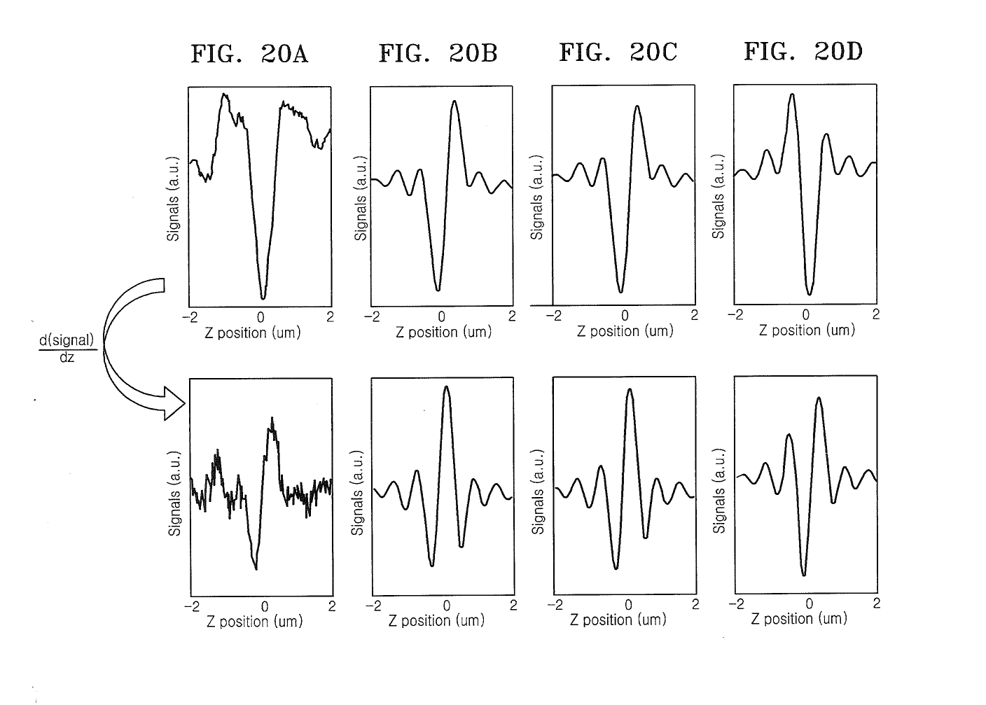

FIGS. 16A through 16D are optical intensity profiles of respective ones of FIGS. 14A through 14D according to various focus positions in a depth direction (z-axis direction) at a x-axis value and derivative optical intensity profiles of the respective optical intensity profiles relative to the depth direction.

The upper graphs of FIGS. 16B through 16D show optical intensity profiles of the semiconductor device illustrated in FIGS. 14B through 14D according to various focus positions at an x-axis defect point, that is a x-axis value where a defect exists. Since the semiconductor device illustrated in FIG. 14A does not include any defect, the upper graph of FIG. 16A shows an optical intensity profile of the semiconductor device illustrated in FIG. 14A according to various focus positions at the x-axis defect point.

In upper graphs of FIGS. 16A through 16D, a horizontal axis denotes a position of a focus with respect to a depth direction of a focus that may also have a range of about ±2 μm. Meanwhile, a vertical axis denotes an optical intensity, and a.u. denotes an arbitrary unit. As can be seen from the upper graphs, an optical intensity abruptly varies at an in-focus position, that is, at a portion at z=0. This may be explained based on the fact that most reflection is generated on a surface of a semiconductor device when the surface of the semiconductor device is set to an in-focus position.

As illustrated in upper graphs of FIGS. 16A through 16D, different optical intensity profiles according to focus positions may be generated according to a depth of a defect at an x-axis defect point. Accordingly, the optical intensity profiles may be used in extracting defect depth information. For example, when optical intensity profiles according to defect depths at the x-axis defect point are stored in a library database as comparison profiles, and when an optical intensity profile is generated by using variable focus scanning with respect to a predetermined semiconductor device which is the inspection object 500, if a matching comparison profile is found upon comparing the generated optical intensity profile with the comparison profiles stored in the library database, defect depth information of the matching comparison profile may be obtained as defect depth information of the inspected semiconductor device.

The lower graphs of FIGS. 16A through 16D show derivative optical intensity profiles of the respective optical intensity profiles in the upper graphs of FIGS. 16A through 16D relative to the depth direction. In the lower graphs of FIGS. 16A through 16D, a horizontal axis denotes a position of a focus with respect to a depth direction and may also have a range of about ±2 μm. A vertical axis denotes derivative optical intensity profiles.

As illustrated in lower graphs of FIGS. 16A through 16D, different derivative optical intensity profiles are generated according to defect depths. Accordingly, the derivative optical intensity profiles may also be used in extracting defect depth information. Methods of using the derivative optical intensity profiles are similar to those discussed with reference to the optical intensity images or the optical intensity profiles.

In some embodiments, comparison using comparison images or comparison data (comparison profiles or comparison derivative profiles) stored in the library database may be conducted by comparing positions, sizes, or magnitude of critical points. It may be difficult to set a critical point in, for example, an optical intensity image. However, in case of an optical intensity profile or a differentiation signal profile, a maximum point or an inflection point thereof may be set as a critical point. Therefore by comparing a position, a size, or a magnitude of a critical point thereof with a position, a size, or a magnitude of comparison data stored in the library database at the critical point, the matching comparison data may be found, relatively easily and quickly. Thus, defect depth information of an inspected semiconductor device may be obtained relatively quickly and accurately.

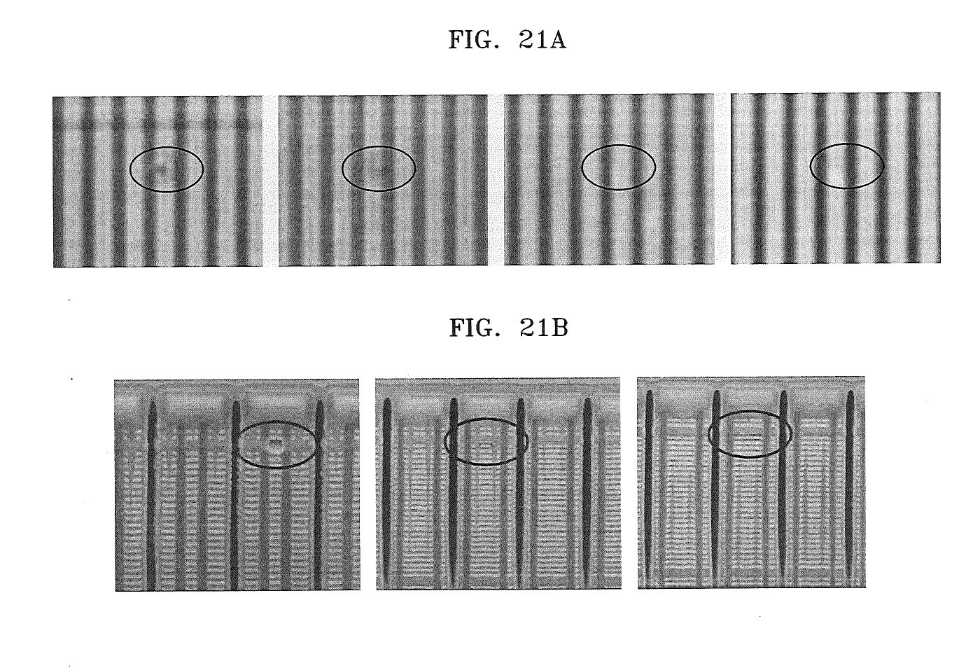

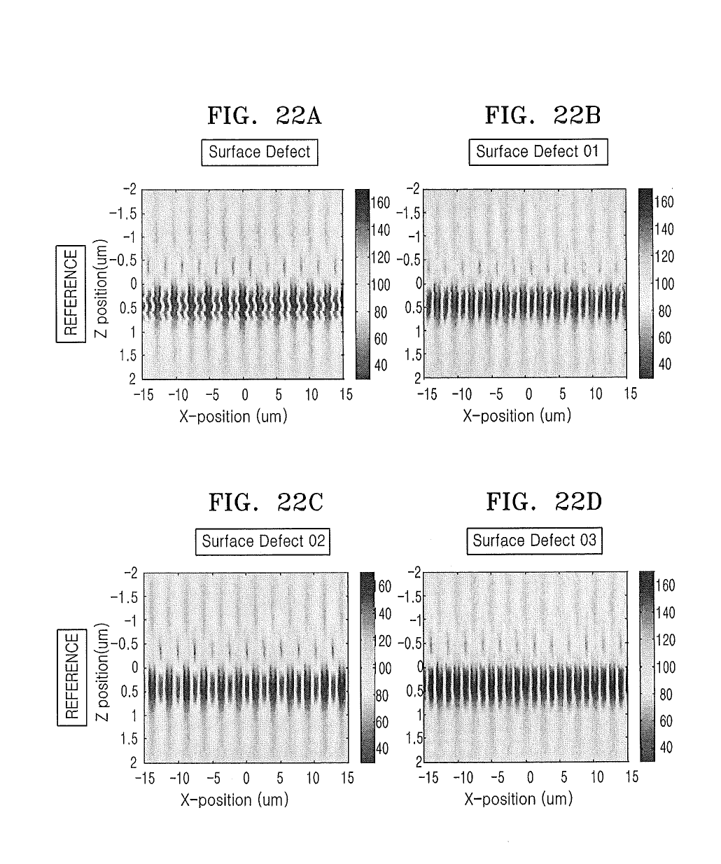

FIG. 17 is a perspective view of a semiconductor device including a bridge defect, and FIGS. 18A through 18D are cross-sectional views illustrating the semiconductor device of FIG. 17 according to bridge depths.

Referring to FIG. 17, an inspection object 500 such as a semiconductor device may include a pattern such as a line-and-space pattern and a bridge defect D0 may exist in a portion of the line-and-space pattern. A line pattern L may denote linear patterns formed through first to third inner layers 520, 530, and 540, and a space S may denote spaces between lines of the line pattern L. An uppermost layer 510 may cover a portion above the line pattern L and the spaces S.

Although the bridge defect D0 in FIG. 17 is illustrated that it is formed through the first, second and third inner layers 520, 530, and 540 of the semiconductor device, and the bridge defect D0 may be formed through the first to third inner layers 520, 530, and 540, through the second and third inner layers 530 and 540, or only through the third inner layer 540 as illustrated in FIGS. 18B through 18D,

FIGS. 18A through 18D are cross-sectional views illustrating a portion of the inspection object 500 where the bridge defect D0 exists. In detail, FIG. 18A illustrates a cross-section of the inspection object 500 not including a bridge defect, FIG. 18B illustrates a cross-section thereof where a bridge defect D1 exists through the first to third inner layers 520, 530, and 540, FIG. 18C illustrates a cross-section thereof where a bridge defect D2 exists through the second and third inner layers 530 and 540, and FIG. 18D illustrates a cross-section thereof where a bridge defect D3 exists through on the third inner layer 540.

Although a bridge defect is formed in different layers and in different thicknesses as described above, if the bridge defect is inspected using a typical scanning method, almost the same or similar optical signal images may be obtained.

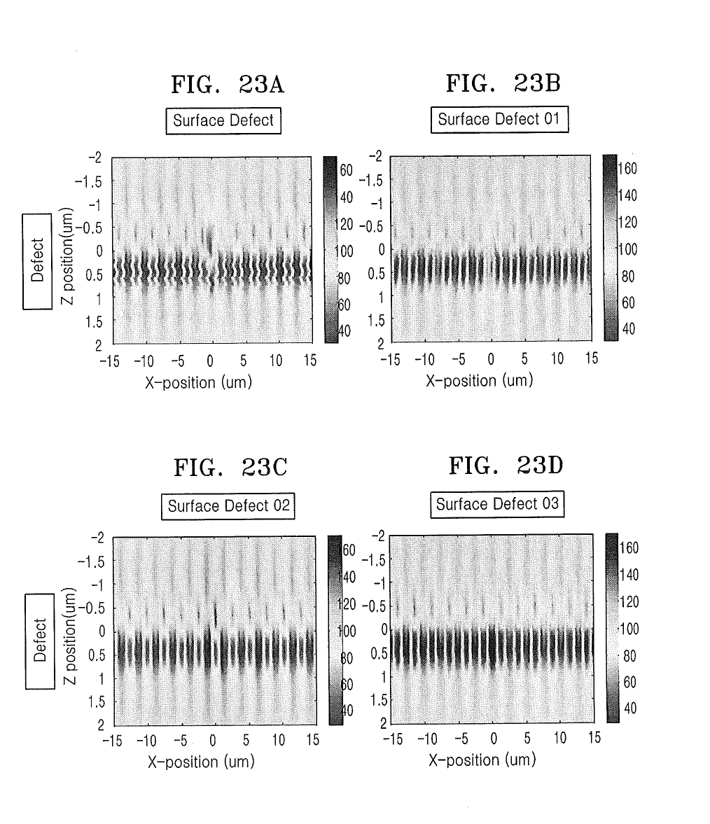

FIGS. 19A through 19D are photographic optical intensity images of the respective cross-sectional views in FIGS. 18A through 18D obtained using a variable focus scanning method according some embodiments of the present inventive concept.

Referring to FIGS. 19A through 19D, different optical intensity images may be generated according to a depth or a thickness of a bridge defect when a variable focus scanning method is applied to analyze the bridge defect having different depths or thicknesses. Accordingly, the optical intensity images may be used to extract defect depth information of the bridge defect.

A method of obtaining optical intensity images of the particle defect and a method of using the optical intensity images of the particle defect has been described above with reference to FIGS. 15A through 15D, and the same or similar methods may be applied to obtain or use an optical intensity image of a bridge defect.

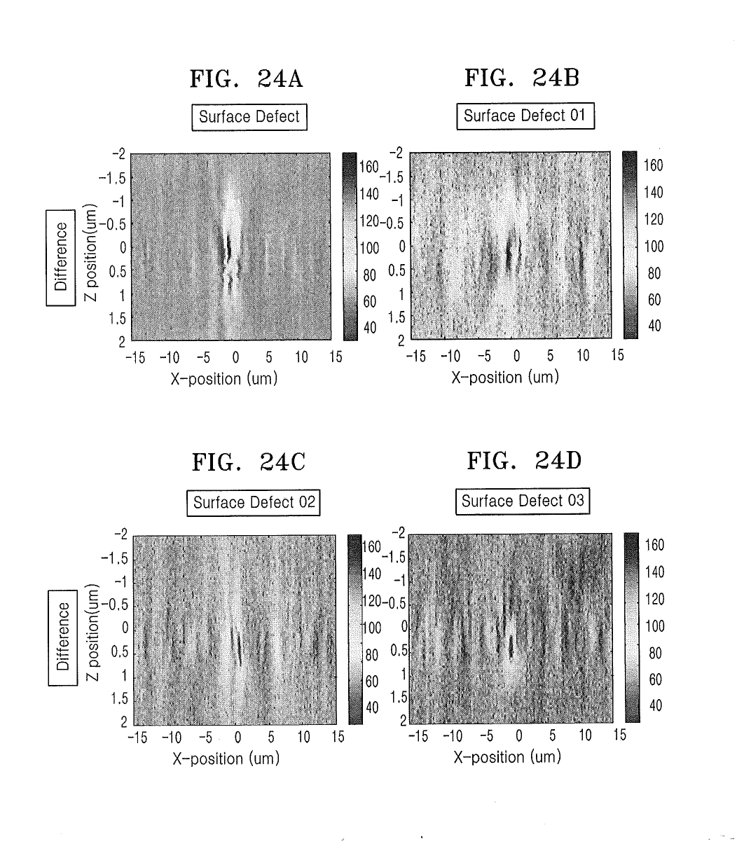

FIGS. 20A through 20D are optical intensity profiles of respective cross-sectional views in FIGS. 18A through 18D according to focus positions in a depth direction (z-axis direction) at a x-axis value and derivative optical intensity profiles of the respective optical intensity profiles relative to the depth direction.

As illustrated in FIGS. 20A through 20D, different optical intensity profiles and derivative optical intensity profiles relative to the depth direction at an x-axis defect point may be generated when depths or thicknesses of a bridge defect are different. Accordingly, the optical intensity profiles and the derivative optical intensity profiles relative to the depth direction may be used to extract defect depth information of the bridge defect.

A method of obtaining or using an optical intensity profile or a derivative optical intensity profiles relative to the depth direction at an x-axis defect point has been described above with reference to FIGS. 16A through 16D with respect to the particle defect. The same or similar methods may be applied to a bridge defect.

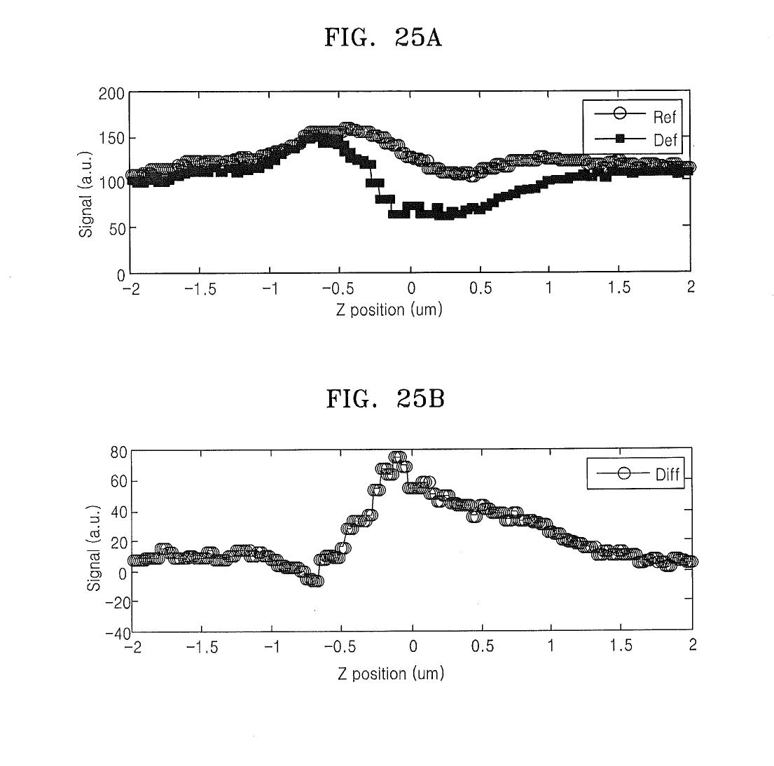

FIG. 21A provides optical images of a vertical NAND (VNAND) device from a plan view according to defect positions, and FIG. 21B provides vertical cross-sectional images of a VNAND device including a defect.

Referring to FIGS. 21A and 21B, FIG. 21A shows optical images of a VNAND device obtained by using a typical scanning method, where a horizontal axis of graphs may be an x-axis, and a vertical axis of the graphs may be a y-axis. That is, FIG. 21A shows planar optical images obtained by typical scanning with respect to the VNAND device having a line-and-space pattern.

As illustrated in FIG. 21A, a position of a defect may be detected but it is difficult to find out where the defect is located in a depth direction. In FIG. 21A, black circles may indicate the position of the defect on an x-y plane.

FIG. 21B shows vertical cross-sections including a defect in an inner layer of the VNAND device. The vertical cross-sections of FIG. 21B may be a SEM or TEM photographic image. However, since a sample, that is, a semiconductor device, has to be destructed in order to perform the SEM or TEM analysis as described above, the SEM or TEM analysis may not be appropriate as an in-line monitoring tool. However, when a typical scanning method is used as described above with reference to FIG. 21A, defect depth information may not be obtained.

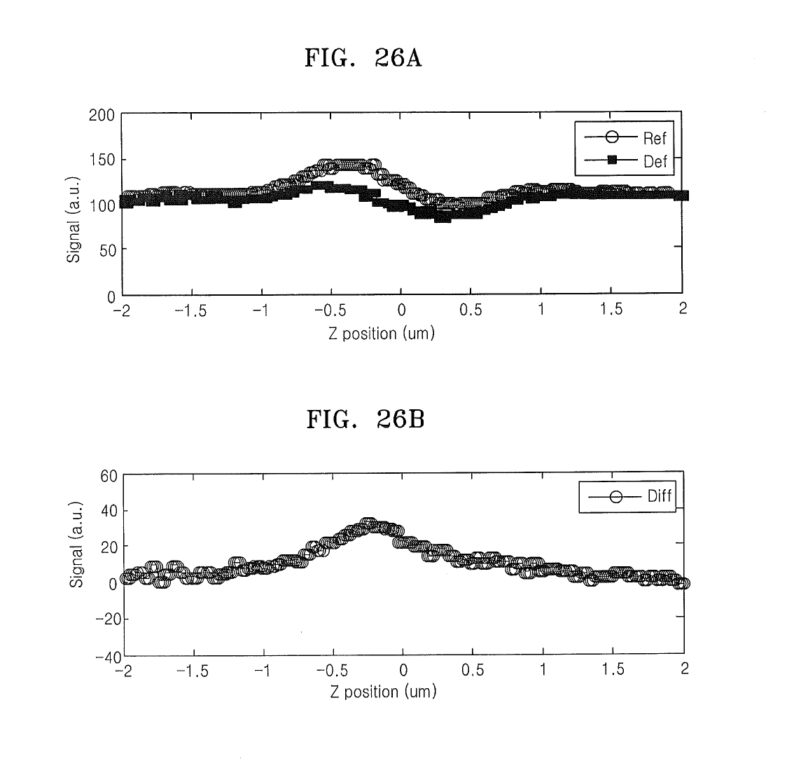

The optical intensity images as illustrated in FIGS. 15A through 15D or FIGS. 19A through 19D may be obtained by using a variable focus scanning method and may be used to extract defect depth information. In some embodiments, a method described with reference to FIGS. 22A through 22D, 23A through 23D, 24A through 24D, 25A, 25B, 26A, 26B, 27A, 27B, 28A, and 28B, and 29 may be used.

FIGS. 22A through 22D are photographic optical intensity images (reference images) obtained by using a variable focus scanning method at a predetermined y-axis value where no defect exists on a x-y plane.

Referring to FIGS. 22A through 22D, optical intensity images are obtained by using a variable focus scanning method as discussed with reference to FIGS. 15A through 15D or FIGS. 19A through 19D. However, those optical intensity images may be obtained at y-axis values where no defect exists on an x-y plane. The optical intensity images obtained at the y-axis values with no defect may be set as reference images.

In detail, FIG. 22A may be a reference image of a semiconductor device including a defect on a surface, and FIG. 22B may be a reference image of a semiconductor device including a defect in a first inner layer. FIG. 22C may be a reference image of a semiconductor device including a defect in a second inner layer, and FIG. 22D may be a reference image of a semiconductor device including a defect in a third inner layer. As illustrated in FIGS. 22A through 22D, the reference images may be similar to each other regardless of the positions of the defects.

Meanwhile, at least one reference image may be extracted. That is, at least one y-axis adjacent to a y-axis value at which a defect exists may be selected, and a variable focus scanning method may be applied to the selected y-axis value to thereby obtain an optical intensity image as a reference image.

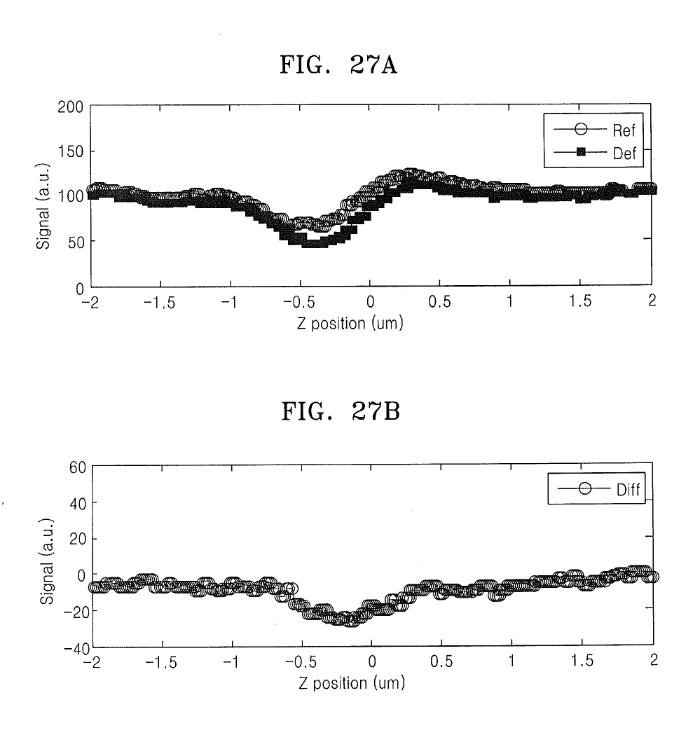

FIGS. 23A through 23D are photographic optical intensity images (defect images) obtained by using a variable focus scanning method at a predetermined y-axis value where a defect exists on a x-y plane.

Referring to FIGS. 23A through 23D, optical intensity images are obtained by using a variable focus scanning method at a y-axis value where a defect exists on a x-y plane. As described above, an optical intensity image obtained at a y-axis value where a defect exists may be set as a defect image. Meanwhile, as there is a single y-axis value corresponding to a defect, just a single defect image may be extracted.

In detail, FIG. 23A may be a defect image of a semiconductor device including a defect on a surface, and FIG. 23B may be a defect image of a semiconductor device including a defect in a first inner layer. FIG. 23C may be a defect image of a semiconductor device including a defect in a second inner layer, and FIG. 23D may be a defect image of a semiconductor device including a defect in a third inner layer. As illustrated in FIGS. 23A through 23D, the defect images in FIGS. 23B, 23C and 23D may be similar to each other regardless of the positions of the defects.

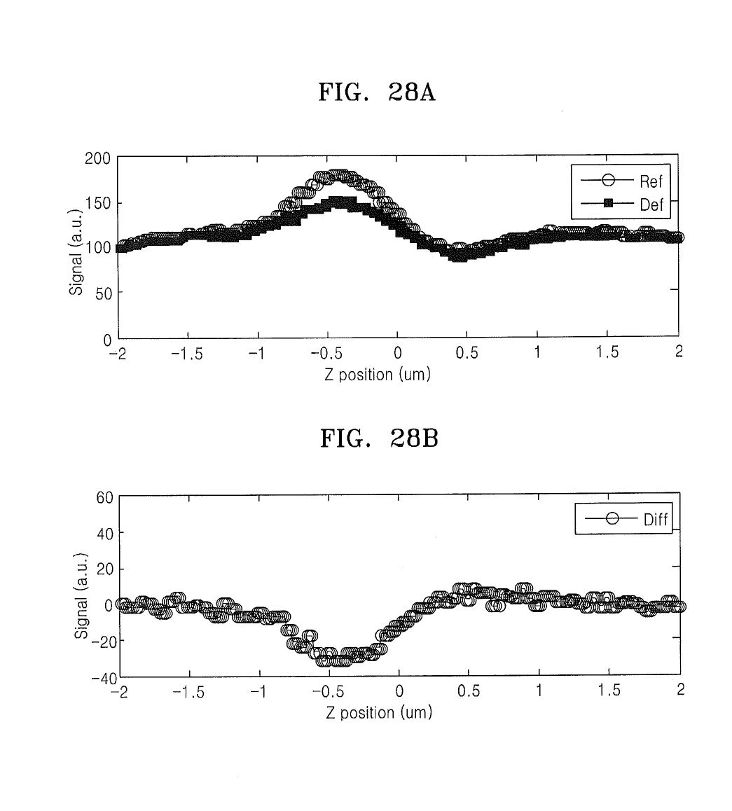

FIGS. 24A through 24D are photographic images of difference images between the reference images of FIGS. 22A through 22D and the respective defect images of FIGS. 23A through 23D.

Referring to FIGS. 24A through 24D, difference images are obtained by subtracting the defect images of FIGS. 23A through 23D from the respective reference images of FIGS. 22A through 22D. As can be seen from FIGS. 24A through 24D, the difference images are different according to positions of the defect. Also, a portion of each of the difference images corresponding to an x-axis value at which a defect exists, for example, a portion corresponding to x=0, is different from the rest of portions of the difference images. This is because optical intensities of the rest of the portions of the image except the x-axis value portion where the defect exists may be almost the same or similar regardless of the y-axis values, and thus, differences in these portions may be highly likely to be uniform. Accordingly, except the portion corresponding to the x-axis at which the defect exists, most of the rest of the portions may be seen in almost the same or similar tone of color.

The difference images that are shown differently according to depths of the defect may also be used in extracting defect depth information. For example, when difference images with respect to the respective defect depths are stored in a library database as comparison data, and a difference image may be generated by performing variable focus scanning with respect to a predetermined semiconductor device which is an inspection object, and the generated difference image may be compared with the comparison data stored in the library database to find matching comparison data. Then, defect depth information of the comparison data may be obtained as defect depth information of the inspected semiconductor device.

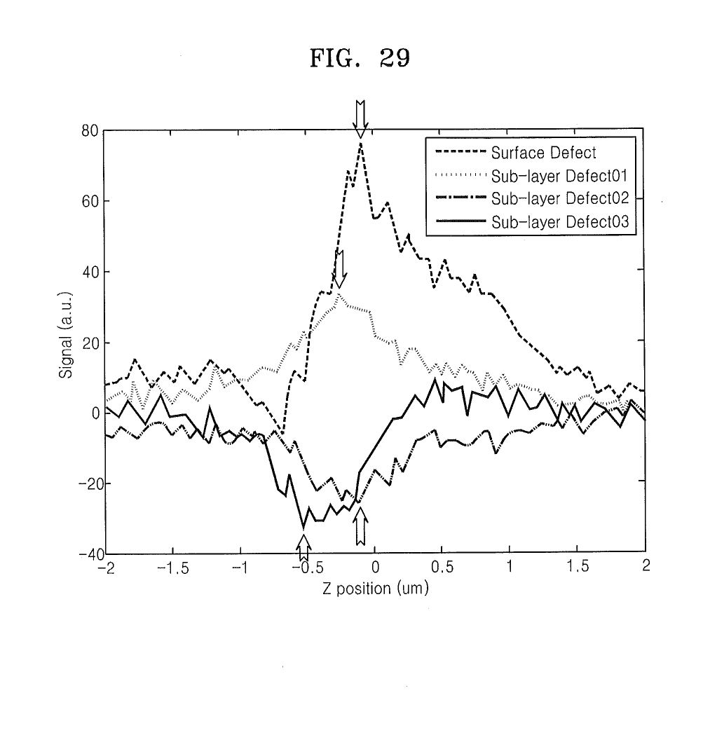

FIGS. 25A, 26A, 27A and 28A are graphs showing optical intensity profiles at a predetermined defect point on a x-y plane (a defect signal profile) and optical intensity profiles at another predetermined point different from the defect point (a reference signal profile). FIGS. 25B, 26B, 27B and 28B are difference signal profiles between the defect signal profiles and the respective reference signal profiles.

FIGS. 25A and 25B are obtained from a semiconductor device including a defect on a surface. FIG. 25A is a graph showing an optical intensity profile extracted at a predetermined point on a x-y plane in the same manner as the upper graphs of FIGS. 16A through 16D. However, while an optical intensity profile is extracted only from the defect point in FIGS. 16A through 16D, according to FIG. 25A, optical intensity profiles are extracted from a defect point and from another point as well. In FIG. 25A, small black rectangles (Def) indicates a defect signal profile, which is an optical intensity profile extracted from a defect point, and small circles (Ref) indicates an optical intensity profile extracted from the another point and may be a reference signal profile. The another point may be a predetermined point adjacent to the defect point. FIG. 25B is graph showing a difference signal profile between a defect signal profile and a reference signal profile. As illustrated in FIG. 25B, while the defect signal profile and the reference signal profile have similar shapes, the difference signal profile may have a different shape from that of the defect signal profile or the reference signal profile.

FIGS. 26A and 26B are obtained from a semiconductor device including a defect in a first inner layer. Similar to FIGS. 25A and 25B, FIG. 26A is a graph showing a defect signal profile and a reference signal profile, and FIG. 26B is a graph showing a difference signal profile. FIGS. 27A and 27B are obtained from a semiconductor device including a defect in a second inner layer and FIGS. 28A and 28B are obtained from a semiconductor device including a defect a third inner layer. FIGS. 27A and 28A are graphs each showing a defect signal profile and a reference signal profile, and FIGS. 27B and 28B are graphs each showing a difference signal profile.

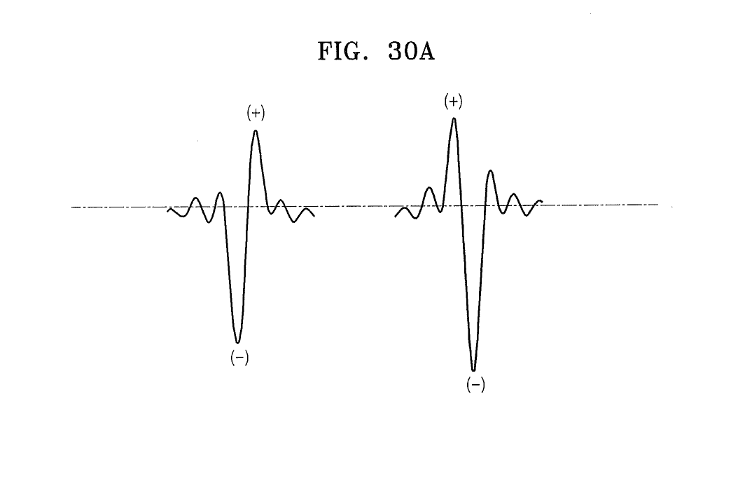

FIG. 29 is a graph showing the difference signal profiles of FIGS. 25B, 26B, 27B, and 28B. Referring to FIG. 29, as denoted by arrows, the difference signal profiles have peaks at different z-axis positions. Also, polarities of the peaks may vary according to positions of the defect. For example, the difference signal profiles of the semiconductor device including the defect on a surface (Surface Defect) and of the semiconductor device including the defect in a first inner layer (Sub-layer Defect01) have peak polarities in a direction toward a maximum, and the difference signal profiles of the semiconductor device including the defect in a second inner layer (Sub-layer Defect02) and of the semiconductor device including the defect in a third inner layer (Sub-layer Defect03) have peak polarities in a direction toward a minimum.

Since the peak positions or the peak polarities are different in the difference signal profiles, characteristics of the peaks may be used in extracting defect depth information. For example, when difference signal profiles are stored in a library database as comparison data, the peak characteristics may be used when comparing the obtained difference signal profiles and the comparison data in the library database to thereby easily find matching comparison data. Accordingly, defect depth information of an inspected semiconductor device may be obtained quickly and accurately.

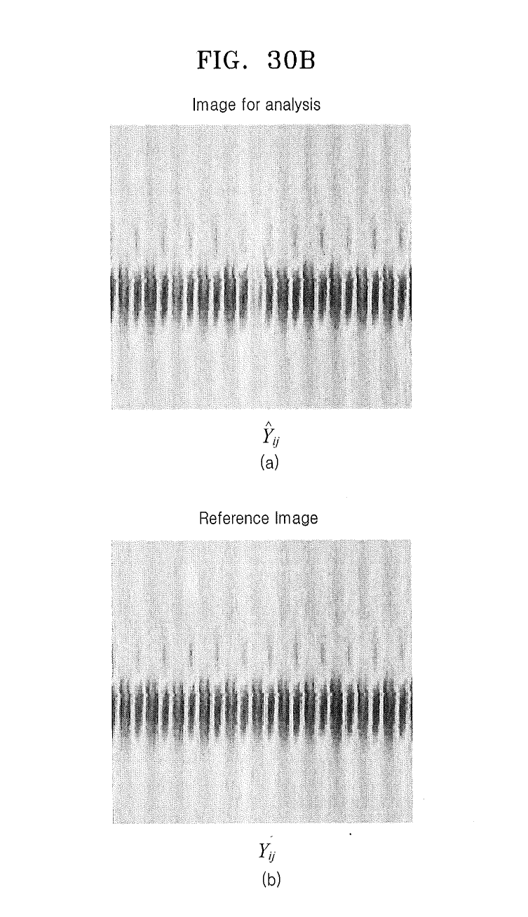

FIG. 30A is a signal waveform diagram for explaining an interferogram analysis as a signal analyzing method, and FIG. 30B shows a reference image (a) and a defect image (b) for explaining a mean square error (MSE) analysis as a signal analyzing method.

Referring to FIG. 30A, in an apparatus for extracting defect depth information according to some embodiments of the present inventive concept, defect depth information may be extracted by using a typically used analysis method such as an interferogram analysis method in addition to the above-described various comparative analysis methods. For example, as illustrated in FIG. 30A, interferogram graphs may be obtained, and then data of the interferogram graphs may be compared with comparison data stored in the library database in terms of polarity, period, or frequency, and amplitude ratio so as to extract defect depth information. For reference, an interferogram may refer to a variation in interference light intensity when varying a light path difference of a two-light linear speed interference system, which is measured and recorded as a function of a light path difference.

Referring to FIG. 30B, in an apparatus for extracting defect depth information according to some embodiments of the present inventive concept, defect depth information may be extracted by using a MSE analysis method besides the interferogram analysis method. For example, the illustrated images (a) and (b) may be respectively be a defect image and a reference image as those described above with reference to FIGS. 22A through 22D and FIGS. 23A through 23D. That is, the image (a) in the upper portion of FIG. 30B may be a defect image to be analyzed, and the image (b) in the lower portion of FIG. 30B may be a reference image.

Meanwhile, the images may be allocated with an optical intensity or a color value corresponding to the optical intensity in units of cells on an x-z plane. A MSE of the images may be calculated according to Equation (3) in units of cells as below.

$$MSE = \frac{1}{m \cdot n} {\sum }_{i = 1}^{m} {\sum }_{j = 1}^{n} {( {\hat{Y}}_{ij} - {\hat{Y}}_{ij} )}^{2} \qquad Equation ( 3 )$$

Here, Ŷᵢⱼ denotes the total average optical intensity or color value, and Yij denotes an optical intensity or color value of a cell corresponding to an i-th on a x-axis and a j-th on a z-axis.

After obtaining a MSE through the above calculation, the MSE is compared with comparison MSE values according to defect depths stored in a library database to extract a matching comparison MSE value, and defect depth information of the comparison MSE value may be extracted as defect depth information of the inspected semiconductor device.

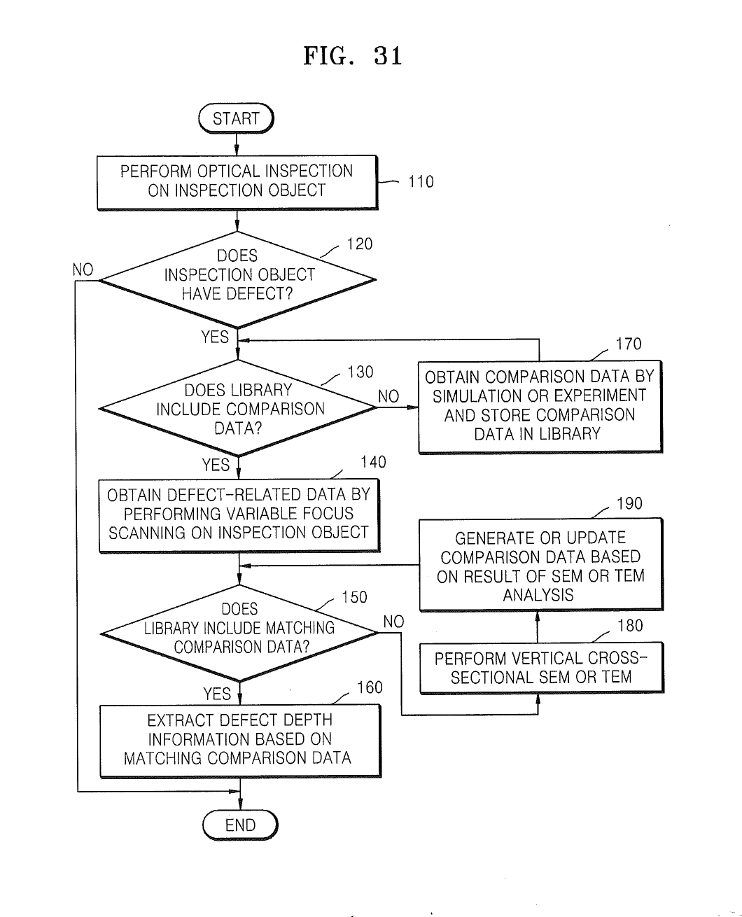

FIG. 31 is a flowchart illustrating a method of extracting defect depth information according to some embodiments of the present inventive concept. Referring to FIG. 31, an optical inspection may be performed with respect to an inspection object in operation 110. An optical inspection may refer to a typical scanning operation. By performing the optical inspection, a defect position on a horizontal plane of an inspection object, for example, on an x-y plane may be detected.

Whether there is a defect on the inspection object may be determined in operation 120. If there is no defect on the inspection object (No), the method of extracting defect depth information may be ended.

When there is a defect in the inspection object (Yes), whether there is comparison data in the library database may be determined in operation 130. The comparison data may be various types of comparison data that may be compared with data that is obtained using focus variable scanning on the inspection object. For example, the comparison data may be an optical intensity image, an optical intensity profile, a differentiation signal profile, a difference image, a difference signal profile, data for interferogram analysis, comparison data that is comparable with MSE. The comparison data may be obtained by simulations or experiments. Also, the comparison data may also be obtained by using variable focus scanning.

When there is no comparison data in the library database (No), comparison data about the corresponding inspection object may be obtained by simulations or experiments and may be stored in the library database in operation 170. After storing the comparison data in the library database in operation 170, the method proceeds again to operation 130 of determining whether there is comparison data in the library database.

When there is comparison data in the library database (Yes), variable focus scanning may be performed on the inspection object at a defect position to obtain defect-related data in operation 140. The defect position indicates a predetermined position on an x-y plane at which a defect is located, and variable focus scanning may refer to performing scanning within a predetermined range along an x-axis with a fixed y-axis value in a z-axis direction while varying a focus position by predetermined units of distance. A range of modification of the focus position in the z-axis direction may be about ±2 μm, and a predetermined unit of distance may be about 40 nm. Meanwhile, a range of scanning in an x-axis direction may be ±0.2 μm.

Defect-related data may be at least one piece of the various types data described above with reference to FIGS. 13 through 30. For example, the defect-related data may be at least one of an optical intensity image, an optical intensity profile, a differentiation signal profile, a difference image, a difference signal profile, data for interferogram analysis, and MSE.

After obtaining the defect-related data, whether there is matching comparison data that matches the defect-related data, in the library database, may be determined in operation 150. When there is matching comparison data (Yes), defect depth information of the inspection object may be extracted based on the matching comparison data in operation 160. The defect depth information is already included in a plurality of pieces of comparison data stored in the library database. Accordingly, just by finding comparison data that matches the defect-related data, information about a defect depth of the inspection object may be immediately obtained.

After obtaining information about the defect depth of the inspection object, the method of extracting defect depth information may be ended.

When there is no matching comparison data (No), vertical cross-sectional SEM or TEM analysis may be performed on the inspection object. The absence of matching comparison data in the library database indicates that the comparison data stored in the library database may be incorrect data. Accordingly, SEM or TEM analysis may be directly performed on the inspection object for accurate analysis.

After performing SEM or TEM analysis, new comparison data may be generated based on a result of the SEM or TEM analysis, or the conventional comparison data stored in the library database may be updated, and the new comparison data or the updated comparison data may be stored in the library database in operation 190.

Thereafter, the method proceeds again to operation 150 of determining whether matching comparison data exists in the library database.

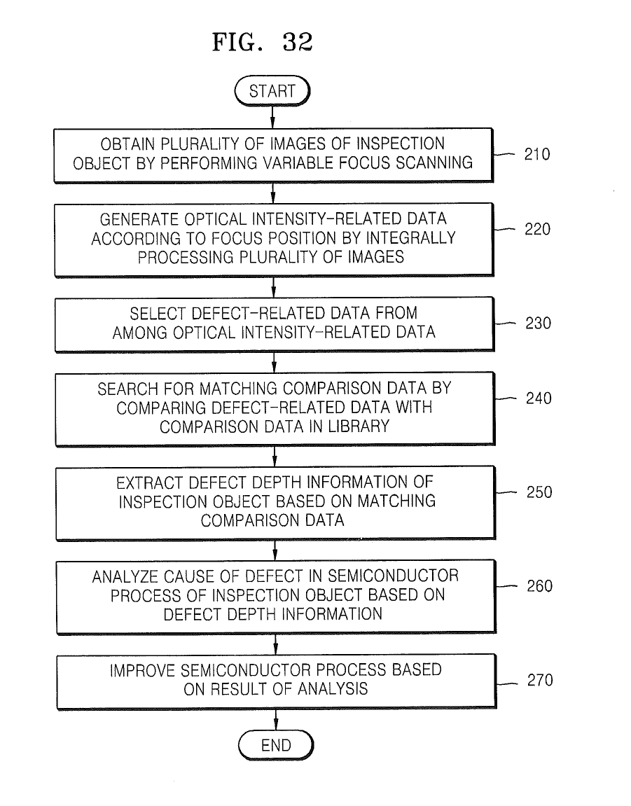

FIG. 32 is a flowchart illustrating a method of improving semiconductor device manufacturing processes by using defect depth information according to some embodiments of the present inventive concept. Referring to FIG. 32, in operation 210, a plurality of images may be obtained by performing variable focus scanning on an inspection object. The variable focus scanning may refer to performing scanning on the inspection object while varying a focus position in a depth direction (z-axis direction) by predetermined units of distance.

The obtained plurality of images may be integrally processed to obtain data related to an optical intensity according to focus positions. The optical intensity related data may be various types of data described above with reference to FIGS. 13 through 30.

In operation 230, defect-related data may be selected among the optical intensity-related data. The defect-related data may be at least one piece of the various types of data described above with reference to FIGS. 13 through 30. That is, optical intensity-related data used to extract defect depth information of an inspection object may be selected as the defect-related data.

In operation 240, the defect-related data may be compared with comparison data stored in the library database to find matching comparison data. The comparison data may be comparison data corresponding to the various types of data described above with reference to FIGS. 13 through 30B, and each of the comparison data may include defect depth information.

In operation 250, defect depth information of the inspection object may be extracted based on the detected matching comparison data. As described above, as defect depth information is included in the comparison data, when a matching piece of comparison data is found, defect depth information of the inspection object may be obtained.

Regarding the method of improving a semiconductor process by using defect depth information according to some embodiments of the present inventive concept, most comparison data may be stored in the library database. Accordingly, acquisition of comparison data by using simulations or the like or acquisition or update of the comparison data according to a result of SEM or TEM analysis may be omitted.

In operation 260, after obtaining the defect depth information, a cause of the defect in a semiconductor process for the corresponding inspection object may be analyzed. In general, when a position of a portion where a defect is generated is accurately detected, it may be determined in which semiconductor process an error is generated. Accordingly, the cause of the error in the corresponding semiconductor process may be analyzed.

After analyzing the cause of the error, a result of analysis may be taken into consideration to improve the semiconductor process in operation 270. By improving the semiconductor process in this manner, the process yield may be increased. In particular, in the case of a VNAND, it may be highly important to detect a defect depth position in view of the characteristics of the structure of the VNAND. Accordingly, the method of improving a semiconductor process by using the defect depth information may be effective in increasing the yield of a VNAND process. Also, the method of improving a semiconductor process by using the defect depth information according to some embodiments of the present inventive concept may be further developed and utilized as a new inspection technique for logic devices.

The above-disclosed subject matter is to be considered illustrative, and not restrictive, and the appended claims are intended to cover all such modifications, enhancements, and other embodiments, which fall within the true spirit and scope of the inventive concept. Thus, to the maximum extent allowed by law, the scope is to be determined by the broadest permissible interpretation of the following claims and their equivalents, and shall not be restricted or limited by the foregoing detailed description.

What is claimed is:

1. An apparatus for extracting defect depth information, comprising:
an optical microscope comprising a focus adjusting assembly configured to change a focus position, wherein the optical microscope is configured to obtain a plurality of images of an inspection object by changing the focus position along a depth direction using the focus adjusting assembly;
an image processor circuit configured to generate an optical intensity image by processing the plurality of images and compare the optical intensity image with comparison images to extract defect depth information; and
a library database configured to store the comparison images comprising a plurality of optical intensity images obtained by simulations or experiments.

2. The apparatus of claim 1, wherein the focus adjusting assembly is configured to change the focus position by mechanically adjusting a position of the inspection object.

3. The apparatus of claim 1, wherein the focus adjusting assembly is configured to change the focus position by adjusting a wavelength of a light irradiated onto the inspection object.

4. The apparatus of claim 3, wherein:
the optical microscope comprises a wavelength tunable laser as a light source; and
the focus adjusting assembly is configured to control the wavelength tunable laser to adjust the wavelength of the light.

5. The apparatus of claim 3, wherein the focus adjusting assembly is configured to adjust the wavelength of the light by using an optical filter.

6. The apparatus of claim 1, wherein the focus adjusting assembly is configured to change the focus position by adjusting a light path of a light irradiated onto the inspection object.

7. The apparatus of claim 6, wherein the focus adjusting assembly is configured to adjust the light path using a plate whose refractive index varies with a radio frequency applied to the plate.

8. The apparatus of claim 1, wherein the image processor circuit comprises:
a signal processor circuit configured to integrally process the plurality of images received from the optical microscope to generate the optical intensity image; and
a comparing and determining circuit configured to compare the optical intensity image and the comparison images stored in the library database to extract the defect depth information.

9. The apparatus of claim 8, wherein the signal processor circuit comprises:
a digital signal processor circuit configured to convert the plurality of images received from the optical microscope to a digital signal;
an optical intensity profile extractor circuit configured to extract an optical intensity profile from the digital signal; and
an optical intensity image generator circuit configured to integrate the optical intensity profile to generate the optical intensity image.

10. The apparatus of claim 1, wherein the image processor circuit is configured to extract at least one of an optical intensity profile of a portion of the inspection object including a defect along the depth direction, a derivative optical intensity profile of a portion of the inspection object including a defect relative to the depth direction, a difference between a first optical intensity image of a first portion of the inspection object including a defect and a second optical intensity image of a second portion of the inspection object not including defects, and a difference between a first optical intensity profile of a third portion of the inspection object including a defect and a second optical intensity profile of a fourth portion of the inspection object different from the third portion.

11. The apparatus of claim 10, wherein the image processor circuit is configured to compare at least one of the optical intensity profile, the derivative optical intensity profile, the difference between the first optical intensity image and the second optical intensity image, and the difference between the first optical intensity profile and the second optical intensity profile with comparison data stored in the library database to extract the defect depth information.

12. The apparatus of claim 1, further comprising a scanning electron microscope (SEM) or a transmission electron microscope (TEM) configured to obtain cross-sectional analysis result of the inspection object,
wherein the library database is configured to be updated the comparison images using the cross-sectional analysis result.

13. An apparatus for extracting defect depth information, comprising:
an optical microscope configured to obtain a plurality of images of a portion of an inspection object including a defect by changing a focus position along a depth direction with a predetermined interval; and
an image processor circuit configured to obtain defect data by integrally processing the plurality of images and compare the defect data with comparison data stored in a library database to extract defect depth information,
wherein the optical microscope is configured to change the focus position by at least one of mechanically adjusting a position of the inspection object, adjusting a light wavelength of a light irradiated onto the inspection object, and adjusting a light path of a light irradiated onto the inspection object.

14. The apparatus of claim 13, wherein:
adjusting the light wavelength comprises adjusting the light wavelength by using a wavelength tunable laser or an optical filter circuit; and
adjusting the light path comprises adjusting the light path by using a plate whose refractive index varies with a radio frequency applied to the plate.

15. The apparatus of claim 13, wherein the library database is configured to store the comparison data obtained by simulations or experiments or is configured to be updated using SEM or TEM analysis result.

16. An apparatus for providing defect depth information, comprising:
an inspection assembly configured to obtain a plurality of optical images of a portion of an inspection object including a defect along a depth direction; and
a processor circuit configured to generate defect data using the plurality of optical images and provide defect depth information by comparing the defect data with comparison data in a library database.

17. The apparatus of claim 16, wherein the defect data comprises an optical intensity profile of the portion of the inspection object, a derivative optical intensity profile of the portion of the inspection object relative to the depth direction, an optical intensity image of the portion of the inspection object, a difference between an optical intensity image of the portion of the inspection object and a reference optical intensity image, or a difference between an optical intensity profile of the portion of the inspection object and a reference optical intensity profile.

18. The apparatus of claim 17, wherein the optical intensity image is obtained by integrating the optical intensity profile.

19. The apparatus of claim 17, wherein the reference optical intensity image comprises an optical intensity image of a portion of the inspection object different from the portion of the inspection object including the defect.

20. The apparatus of claim 16, wherein the processor circuit is configured to provide defect depth information of a matching comparison data as the defect depth information of the defect included in the portion of the inspection object.
